(19) United States
(12) Patent Application Publication
(10) Pub. No.: US 2007/0029826 A1
(43) Pub. Date: Feb. 8, 2007

(54) Robotic system, apparatus and method for forming a curved bumper from a straight bumper bar

(76) Inventor: Jeffrey Allen Bunker, Caledonia, MI (US)

Correspondence Address: Dykema Gossett PLLC;Suite 300, 39577 Woodward Avenue, Bloomfield Hills, MI, 48304, US

(21) Appl. No.: 11/187,770

(22) Filed: Jul. 22, 2005

(51) Int. Cl. B60R 19/32

(52) U.S. Cl. 293/134

(57) ABSTRACT

The robotic system forms a curved bumper from a straight bumper bar and includes a hydraulic press with a die set therein for placing curved surfaces on bumper bars. A gravity feed magazine loader is located on one side of the press and an electronic checking apparatus is located at the other side of the press for measuring the surfaces on curved bumper bars. A robot is located in the space between the loader and the checking apparatus. The robot has an end effecter having a frame and carrying first and second pairs of spaced apart grippers, with the first pair of grippers being closer together than the second pair of grippers. The first pair of grippers picks up and hold a straight bumper bar and it is delivered by the robot from the loader to the hydraulic press and die set. The second pair of grippers picks up and holds the curved bumper after it has been removed by the robot from said hydraulic press and die set and delivered it to the checking apparatus where the bumper surfaces are measured and the data fed to a PLC.

### BACKGROUND OF THE INVENTION

1. Field of the Invention

The present invention relates generally to a robotic system and to the apparatus, equipment and method used in the manufacture of tubular bumpers for motor vehicles.

2. Description of the Requirements For Bumpers in the Automotive Industry

Bumper beams or cross members for vehicles, particularly automobiles, are made from high strength or ultra-high strength steel. It has been difficult to manufacture the bumper beam or bar out of some high strength steel because such bar requires a curvature to be placed therein. It has been necessary in the past to roll-form the cross member to obtain the desired curvature. When high strength steel is roll-formed into the desired sweep or curvature, the material of the cross members is often damaged during the process, resulting in unacceptable quality. The high strength obtainable with such steels is desired in order to provide a bumper beam or bar which can be impacted at high strengths of up to 5 mph without resulting damage.

It is desired for certain applications where high strength is needed to use higher carbon steels, frequently alloyed with other materials. Such steels are characterized as “high-strength steels” Within this category there is a class defined as “ultra-high strength steel”. Such steel has a minimum yield of 100 ksi (100,000 pounds per square inch). Chemical compositions for such steel vary from one producer to another. Different compositions and thermo-mechanical processing may produce equivalent results. Formability of high strengths steels is more difficult than with low carbon steels because of greater spring-back and reduced ductility.

The automotive industry requires that bumpers maintain a high level of strength and damage resistance to meet the expectations of the consumer and government regulations throughout the world concerning low speed vehicular impact. The bumper must be of low weight to minimize vehicle dead weight which reduces gas mileage and increases suspension requirements. In addition, bumpers must have a low manufacturing cost and a high dimensional consistency. Thus, high strength-to-weight ratios and ease of manufacture are of importance to the automotive industry.

3. Description of the Prior Art

Various systems, methods and equipment have been employed to manufacture tubular roll-formed automotive bumpers or cross members such as disclosed in the Sturrus, et al., U.S. Pat. Nos. 5,306,058, 5,092,512 and 5,104,026, each relating to a tubular bumper beam, method and/or apparatus for roll-forming an automotive bumper in a one line system. The same equipment and methods employed in the foregoing patents have also been used to manufacture “B” section cross members as disclosed in the Sturrus' U.S. Pat. No. 5,395,036, entitled “Method of Roll-Forming an End Automotive Bumper”; and U.S. Pat. Nos. 5,454,504, 5,566,874 and 5,813,594, entitled “Apparatus for Forming an End Bumper for Vehicles”. The roll former methods and apparatuses disclosed in the foregoing patents have certain disadvantages, including the fact that the roller equipment for forming the sweep in the cross members are connected with the roll formers in one line, with the severing of the cross member from the roll-formed member being located downstream of the welding station. With such a process, the curvature or sweep is placed in the cross member prior to cutting the swept integral tube.

The prior art roll formers use rollers for producing a constant sweep, meaning the sweep is in an arc. If the arc is continued it will come around and form a circle. Thus, the use of the prior art roll formers and rollers can not produce a non-constant sweep as is a feature of the apparatus of the present invention.

The use of the prior art roll formers with an integral in line sweep mechanism requires that periodically the bumpers be placed on a fixture and the curvature of the bumper measured by hand held probes or feelers to determine whether the bumper meets specifications. If errors are found, then the roll forming process must be stopped to correct the equipment and by that time the process may have produced one to two hundred bumpers which do not meet specification. Thus, such bumpers must be scrapped. The present invention has an electronic checking apparatus which automatically measures each bumper after the curvature has been placed therein. If errors are found in the bumper surface, the data is automatically fed back to the PLC which adjusts the servo-motors and wedges of the die inserts automatically thereby correcting the errors, resulting in only one bumper Which must be scrapped rather than a substantially greater number of bumpers. The PLC which is tied into the press requires only a second or two after the automatic adjustments of the die inserts have been made to direct the press to recycle and make additional bumpers.

### SUMMARY OF THE INVENTION

It is a feature of the present invention to provide a robotic system for forming in a hydraulic press, a curved or swept bumper from a straight bumper bar made in a roll forming apparatus or mill.

Another feature of the present invention is to provide a robotic system wherein either a constant or non-constant radius or curvature may be placed in the bumper.

Still another feature of the present invention is to provide a robotic system having a hydraulic press with a die set therein, a gravity feed magazine loader, an electronic checking apparatus for measuring the curved surface on the swept bumper bar and a robot with an end effecter for picking up and moving the bumper from the gravity feed magazine loader to the press and die set and after formations in the hydraulic press to the electronic checking apparatus.

Still another feature of the present invention is to provide a robotic system of the aforementioned type, wherein the gravity feed magazine loader is located at the front of the press near one end thereof while the electronic checking apparatus is located at the front of the press near the other end thereof; and a robot rotatable throughout 180 degrees or more is located in front of the hydraulic press and die set in the space between the gravity feed magazine loader and the electronic checking station.

A further feature of the present invention is to provide a robotic system of the aforementioned type wherein the robot has an end effecter having a frame provided with first and second pairs of spaced apart grippers, with the first pair of grippers being closer together than the second pair of grippers.

A still further feature of the present invention is to provide a robotic system of the aforementioned type wherein the first pair of grippers is designed to pick up and hold a straight bumper bar which is delivered by the robot from the magazine loader to the hydraulic press and die set.

Another feature of the present invention is to provide a robotic system of the aforementioned type wherein the second pair of grippers is designed to pick up and hold the curved bumper bar after it has been removed by the robot from the hydraulic press and die set and delivered to the electronic checking apparatus.

Still another feature of the present invention is to provide a robotic system of the aforementioned type wherein the robot when unloaded is rotated from the electronic checking apparatus to the gravity feed magazine loader where the sequence of the operation is repeated where the first pair of grippers pick up and hold a straight bumper bar and is thereafter delivered by the robot to the hydraulic press and die set.

A further feature of the present invention is to provide a robotic system of the aforementioned type wherein the robot rotates to 90 degrees between the gravity feed magazine loader and the hydraulic press and die set, rotates 90 degrees between the hydraulic press and die set and electronic checking apparatus and rotates 180 degrees between electronic checking apparatus and gravity feed magazine loader.

A still further feature of the present invention is to provide a gravity feed magazine loader which has a low end and a high end and has a downwardly sloping top surface which includes a pair of laterally spaced apart roller conveyors, with the loader being manually loaded at the high end of the loader to permit the straight bumper bar to be delivered by the rollers by gravity to the low end of the loader.

Another feature of the present invention is to provide at the front end of the gravity feed magazine loader a pneumatically operated lifting device for raising the adjacent bumper bar from the top surface of the table to a loading position which permits the bumper bar to be gripped by the first pair of grippers provided on the end effecter.

Still another feature of the present invention is to provide an electronic checking apparatus which has an inclined top surface and includes laterally spaced apart rollers extending from one end to the other end, with the apparatus including a second frame with legs at the corner, including a frame support on which is mounted an ejecter mechanism having an open position and a closed position.

A further feature of the present invention is to provide an electronic checking apparatus of the aforementioned type wherein a slide is mounted on the second frame for receiving and positioning a curved bumper and an electronic fixture is carried by the slide and is moved over the curved bumper for electronically measuring the curvature of the curved bumper at various locations.

A still further feature of the present invention is to provide a die set for forming a curved bumper from a straight bumper bar, with the die set having an elongated upper plate for supporting the top die tooling, a lower plate for supporting the wedge adjustment tooling and an elongated intermediate plate disposed between the top die tooling and the wedge adjustment tooling for supporting the bottom die tooling. With such construction, a center opening is provided in the intermediate plate and a center pedestal is located in the center opening with the bottom of the pedestal supported by the bottom plate.

Another feature of the present invention to provide a die set of the aforementioned type wherein a series of transfer blocks are located in the center opening on opposite sides of the pedestal, with each transfer block having a top surface which is flat and a bottom surface which is tapered. With such a construction a series of wedges are located on opposite sides of the pedestal, one wedge for each of the transfer blocks, with the top surfaces of the wedges being tapered and engagable with the opposing bottom surfaces of the transfer blocks and actuating means are connected to each wedge for adjusting the corresponding transfer block.

Still another feature of the present invention is to provide a die set of the aforementioned type wherein a contour cut male sweep mandrel is mounted above the transfer blocks and includes a centrally located block secured on the lower end to the pedestal. With such a construction the mandrel includes a series of vertically adjustable inserts located on opposite sides of the support block, with one insert overlying and being aligned with one of the transfer blocks and the corresponding wedge. With such a construction the top surfaces of the inserts of the mandrel have an upstanding curve center support located between a pair of elongated recesses extending from one insert at one end of the mandrel to the insert at the other end of the mandrel.

A further feature of the present invention is to provide a die set of the aforementioned type wherein the upper plate is located above the mandrel overlying and spaced from the intermediate plate, with the upper plate having on the ends thereof downwardly extending mounting brackets, one bracket on each end of the upper plate. With such a construction, a pair of hydraulic cylinders are mounted outboard of the upper support plate and are carried by the mounting brackets.

A still further feature of the present invention is to provide a die set of the aforementioned type wherein each cylinder has a shaft extending inboard of the brackets beneath the upper plate along a longitudinally extending axis, with a pair of wiper blocks carried by the upper plate and mounted above the male mandrel on the opposing shafts of the hydraulic cylinders. With such a construction, the wiper blocks have curvatures corresponding to the profile of the bumper bar and the hydraulic cylinders, when energized, are driven outward while the hydraulic press drives them downwardly simultaneously across the top of the bumper bar towards opposite ends of the mandrel to provide a radius, curvature or sweep thereon around the male mandrel.

Another feature of the present invention is to provide a die set of the aforementioned type, wherein the opposite ends of the intermediate plate is provided with a hydraulically operated stabilizer including a portion designed to fit within the “B” shaped cross section of the bumper bar to prevent the ends of the bar from twisting and from wandering front to back while at about the same time the wiper blocks are moved downwardly and outwardly away from one another to iron the bumper bar around the mandrel from one end of the bumper bar to the other end of the bumper bar.

Still another feature of the present invention is to provide a die set of the aforementioned type for forming a curved or swept bumper wherein the inserts on each side of the centrally located support block are of different heights, with the one insert adjacent the support block being greater in height than the other inserts.

A further feature of the present invention is to provide a die set of the aforementioned type wherein the centrally located center block is provided with a clamping mechanism for positioning and retaining the bumper bar on the contour cut male sweep mandrel.

Another feature of the present invention is to provide a die set of the aforementioned type wherein the actuating means connected to each wedge is taken from the group comprising a manually adjustable threaded nut with adjustment nuts, a hydraulic cylinder or an electronic servo-ball screw motor.

Other features and advantages of the present invention will be readily appreciated, at the same becomes better understood, after reading the subsequent description when considered in connection with the accompanying drawings.

### BRIEF DESCRIPTION OF THE DRAWINGS

FIG. 1 is a schematic view of the first stage of manufacture using roll forming and related equipment to form a tubular straight cross member, bumper or bumper beam;

FIG. 2 is a top view of the tubular straight cross member;

FIG. 3 is a “B” shape cross section of the cross member taken on the line 3-3 of FIG. 2;

FIG. 4 is a fragmentary perspective view of one end of the cross member illustrating the “B” shape cross section;

FIG. 5 is an elevational view of the curved bumper after it has been processed and bent utilizing the equipment and apparatus of the second stage of manufacture;

FIG. 6 is a schematic plan view of the robotic system illustrating the layout of the equipment used within a safety enclosure;

FIG. 7 is a top or plan view of the robotic system illustrating the hydraulic press and die set, robot, gravity feed magazine loader and the electronic checking apparatus;

FIG. 8 is a front elevational view of the robotic system of FIG. 7;

FIG. 9 is a side elevational view of the robotic system of FIG. 7;

FIG. 10 is a perspective view of the robotic system of FIG. 7;

FIG. 11 is a fragmentary elevational view of the robotic system of FIG. 7 illustrating the end effecter on the robot at the home station where the end effecter is picking up a cross member from the gravity feed magazine loader;

FIG. 12 is a fragmentary elevational view of the robotic system illustrating the robot's end effecter as it is being rotated to the hydraulic press and die set where the curved bumper is picked up by the end effecter, the end effecter rotated 180 degrees to place the straight cross member in the die set;

FIG. 13 is a top view of the electronic checking apparatus for measuring the curvature of the bumper at longitudinally spaced areas;

FIG. 14 is a front view of the apparatus of FIG. 13;

FIG. 15 is an end view of the apparatus of FIG. 13;

FIG. 16 is a perspective view of the apparatus of FIG. 13 and the reject table or station illustrating the slide mechanism and the air cylinders or probes engageable with the outer surface of the bumper;

FIG. 17 is a fragmentary sectional view through the slide and cylinders of the apparatus of FIG. 13;

FIG. 18 is a plan or top view of the gravity feed magazine loader;

FIG. 19 is a side elevational view thereof; and

FIG. 20 is an end view showing the left mechanism for raising the platform carrying the cross member to an elevated position engagement with the robot's end effecter;

FIG. 21 is a perspective view of the robot's end effecter and clutch carrying a straight cross member at one side and a curved bumper at the other side after it has been formed in the hydraulic press;

FIG. 22 is a plan view of the end effecter and clutch of FIG. 21;

FIG. 23 is an end view of the robot's end effecter of FIG. 21;

FIG. 24 a side elevational view of the end effecter of FIG. 21;

FIG. 25 is a perspective view of the full die set which is illustrated in the press of FIG. 10;

FIG. 26 is a perspective view of the top tooling of the die set;

FIG. 27 is a perspective view of the wedge tooling of the die set;

FIG. 28 is a perspective view of the bottom tooling of the die set;

FIG. 29 is a perspective view of the bottom adjustment tooling of the die set;

FIG. 30 is a fragmentary vertical cross sectional view of the die set (without the press) with a straight cross member mounted in the die set and showing the top tooling in a raised position;

FIG. 31 is a fragmentary vertical cross sectional view of the die set (without the press) illustrating the top tooling moved downwardly towards the straight cross member;

FIG. 32 is a fragmentary vertical cross section of view of the die set (without the press) illustrating the top tooling in initial engagement with the cross member;

FIG. 33 is a fragmentary vertical sectional view through the die set (without the press) illustrating the hydraulically operated upper grippers of the top tooling moved outwardly and downwardly over the cross member and the mandrel to place a curvature in the cross member;

FIG. 34 is a vertical transverse cross sectional view (without the hydraulic press) through the die set, illustrating the cross member clamped therein;

FIG. 35 is a transverse cross sectional view through the die set and illustrating one of the servo motor and wedge mechanisms for adjusting the mandrel inserts of the die set;

FIG. 36 is a perspective view of the formation plug used at opposite ends of the mandrel of the die set for entering the ends of the cross member to prevent it from twisting and turning during the formation of the curvature on the bumper;

FIG. 37 is another perspective view of the formation plug of FIG. 36 looking in the opposite direction;

FIG. 38 is a top or plane view of the plug;

FIG. 39 is a side view of the plug;

FIG. 40 is an end view of the plug looking in the direction of arrow 40 of FIG. 38;

FIG. 41-50 inclusive are electrical power distribution circuits for use with the robotic system of the present invention;

FIG. 51 illustrates an electric circuit for one of the wedge adjustment servo drives and motors of the die set;

FIG. 52 is the layout for the programmable logic controller (PLC) rack;

FIG. 53 is a layout of the main enclosure for the electrical controls and the PLC;

FIG. 54 is the main electrical circuit including the PLC;

FIG. 55 is the pneumatic circuit diagram illustrating the various pneumatic cylinders, valves and related air components;

FIG. 56 is a hydraulic circuit diagram illustrating the hydraulic cylinders for operating the end plugs, the center clamp and the hydraulic cylinders of the upper tooling dividing the formation of the curved bumper;

FIG. 57 is a fragmentary transverse cross sectional view through the die set and illustrating, as another embodiment, the use of hydraulic cylinders for actuating the wedges rather than the electronic servo ball screw motors of FIG. 35.

FIG. 58 is another embodiment showing a fragmentary transverse cross sectional view through the die set illustrating the use of manually adjustable threaded rods with adjustment nuts for actuating the wedges;

FIG. 59 is a chart illustrating the sequence of operation of the robotic system.

### DETAILED DESCRIPTION OF THE PREFERRED EMBODIMENT

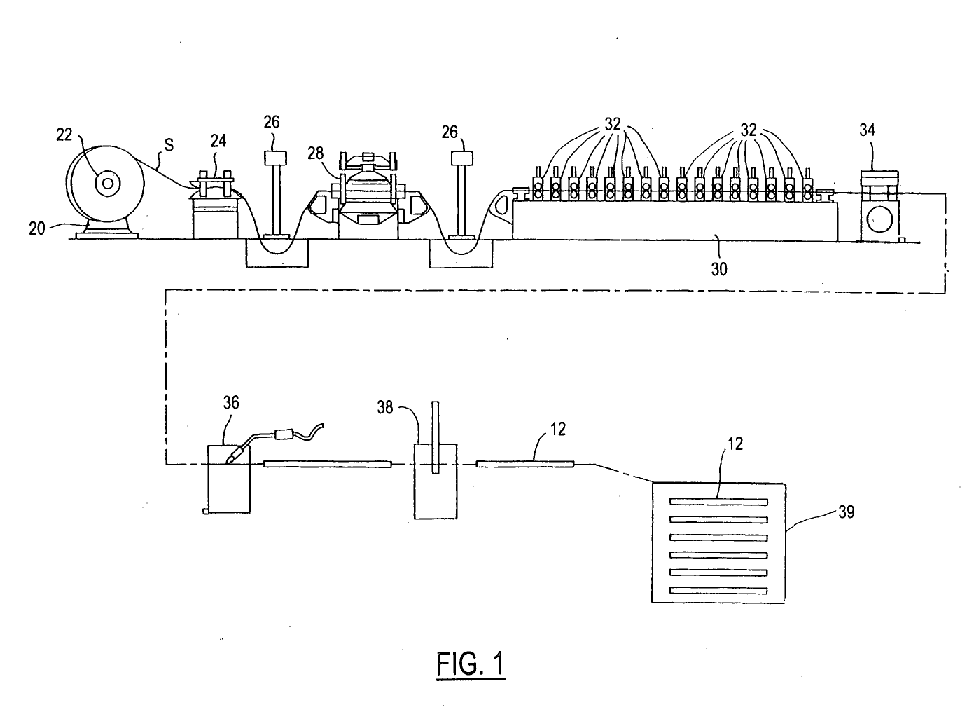

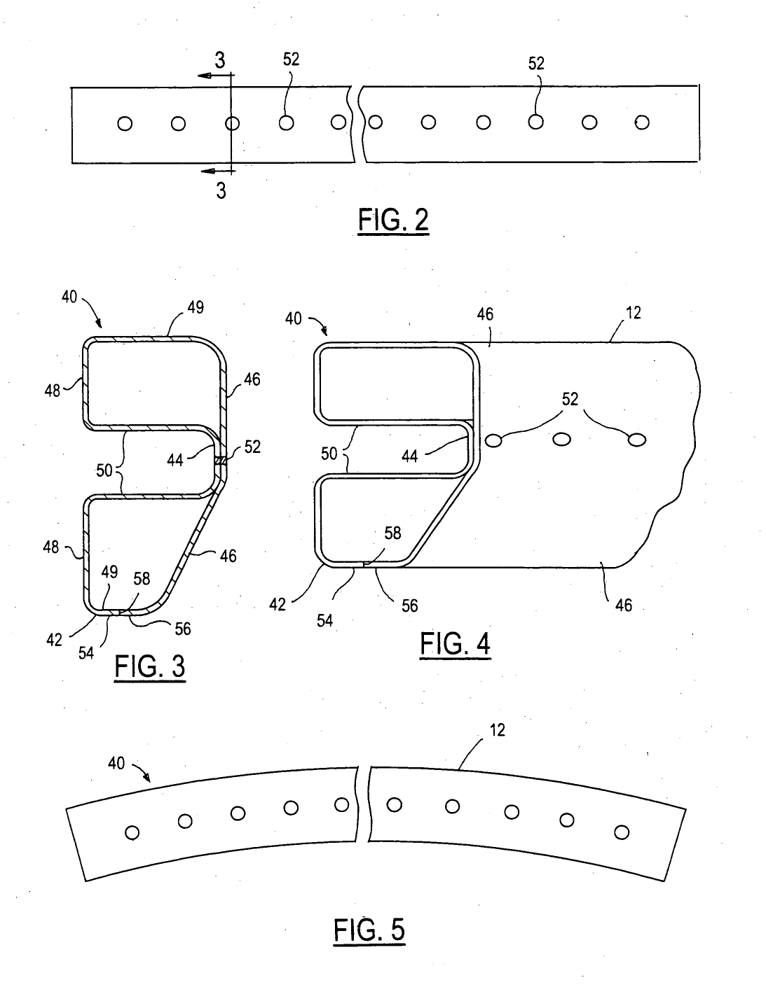

The curved bumper or bumper beam 10 of FIG. 5 is made in two manufacturing stages. The first stage includes a roll forming stage as illustrated in FIG. 1 where a straight tubular cross member 12 is manufactured in an inline system of standard metal forming and welding equipment including a steel roll holder 20 rotatably supporting a roll 22 of strip steel S; and a straightener system or straightener 24 with a pair of guide posts 26 located on opposite sides of the punch press 28. The posts 26 direct the strip steel S as it moves along the line. Downstream of the punch press 28 where mounting openings are placed therein, a roll mill 30 having a series of roll formers 32 are used to shape the B shaped cross section in the straight cross member 12. There are sixteen (16) roll formers 32. Downstream of the trailing or last roll former 32 is a tact or spot welder 34 followed immediately by an inline high frequency welder 36, where the longitudinal edges of the roll formed tubular section are welded together from one end to the other end. A cutoff machine 38 is located downstream of the welder 36 and severs the cross member 12 at the requisite length.

Each straight tubular cross member or beam 12 is a roll form, single sheet of high or ultra high steel having a pair of longitudinal edges which abut and are welded together. The B shaped cross member 12 of FIGS. 3 and 4 includes two side-by-side longitudinally extending tubular sections 40 and 42 which are connected together by a Web 44, each section 40 and 42 having a front wall 46, a rear wall 48, an outer side wall 49 and an inner side wall 50. As a roll form cross member 12 leaves the last roll former 32, the front roll 46 which overlies the web 44 is spot welded to the web 44 at longitudinally spaced areas 52. The spot welds 52 may be placed, as an example from eight to twelve inches apart along the length of the cross member 12. As the welded tubular structure continues to move along the line, the high frequency welder 36 butt welds the longitudinal edges 54 and 56 together from one end to the other. The abutting longitudinal edges 54 and 56, as illustrated in FIGS. 3 and 4, are welded together as represented by the weld line 58.

After the welding steps have been completed, the cutoff machine 38 cuts the straights tubular member 12 to a predetermined length and thereafter the cross member 12 is placed either manually or automatically in a gravity stacking system 39 which is palletized. The B shape cross member 12 which is severed by the cutoff machine 38 is straight from one end to the other. The cross member can be utilized as a straight bumper and mounted on an automobile in place of a curved bumper. The palletizer or collection container 39 is usually spring loaded and the cross members 12 are automatically or manually stacked on the gravity stacking system or apparatus 39.

The method and bending process used to form the tubular straight member 12 from a flat steel strip S is disclosed in detail in the co-pending patent application of Donald G. Graber, Ser. No. 10/894,826 entitled “Cross Member For Vehicle Bumper Bar and Method for Making Same” filed in the U.S. Patent and Trademark Office on Jul. 20, 2004. The Graber patent application is assigned to the assignee of the present invention. The disclosure of the co-pending patent application is incorporated herein by reference.

The gravity stacking system or pallet 39 containing the straight tubular cross members 12 is moved to a remote work station where a second manufacturing stage for forming the curved bumper 10 takes place.

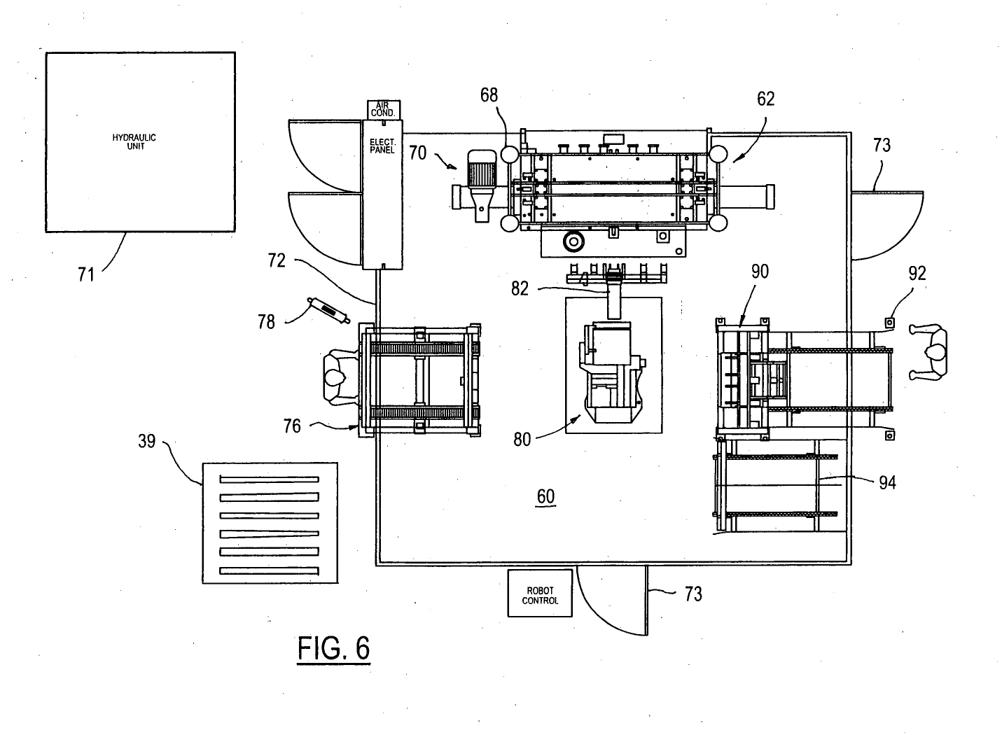

The second stage of manufacturing the curved bumper 10 includes certain novel equipment and apparatuses which are arranged as part of an operating machine schematically illustrated in FIG. 6. The equipment and apparatuses employed form the robotic system designed herein by the numeral 60.

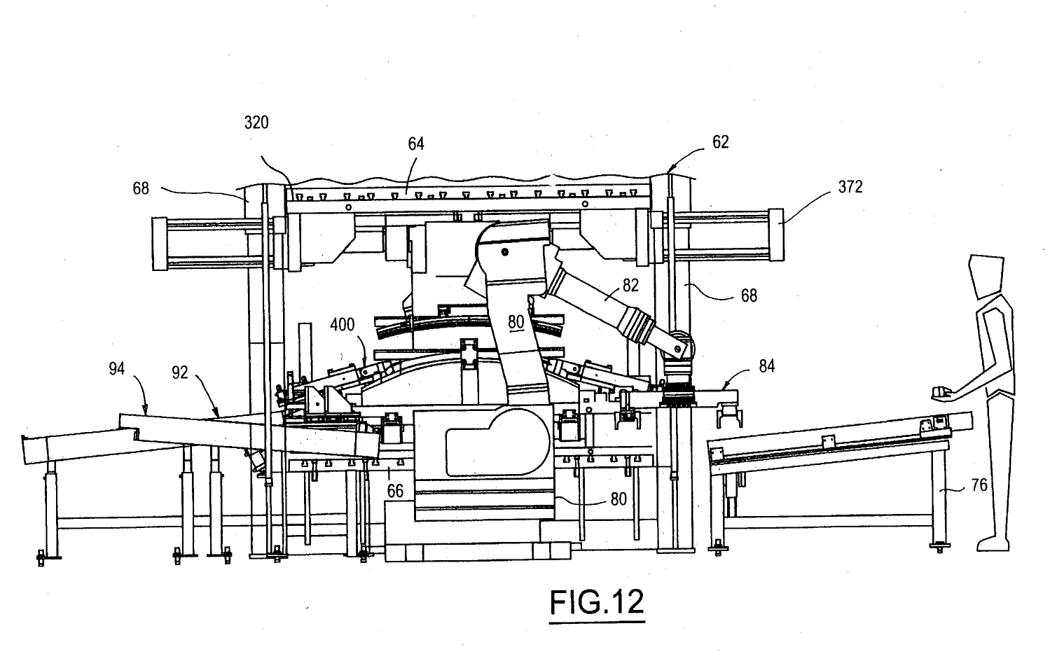

The robotic system 60 includes a hydraulic press 62 having an upper movable press ram or platen 64 and a lower stationary bed or platen 66 as is best illustrated in FIG. 12. The hydraulic press was manufactured by the Beckwood Corporation. It is a four post, down acting, moderate off center loading, straight hydraulic press which is rated for one hundred ton forming capacity and seventy five ton punching capacity. The housing post 68 are illustrated in FIG. 6 at the corners of the press. The press has a 24 GPM hydraulic power system 70 with a ninety gallon oil reservoir 71. The power system 70 provides the hydraulic power for the press 62 as is well known in the art. The hydraulic reservoir 71 is located outside of the normal safety enclosure 72 provided for the equipment and apparatuses of the robotic system 60. The enclosure 72 is provided with doors 73 to provide ingress and egress for maintenance purposes.

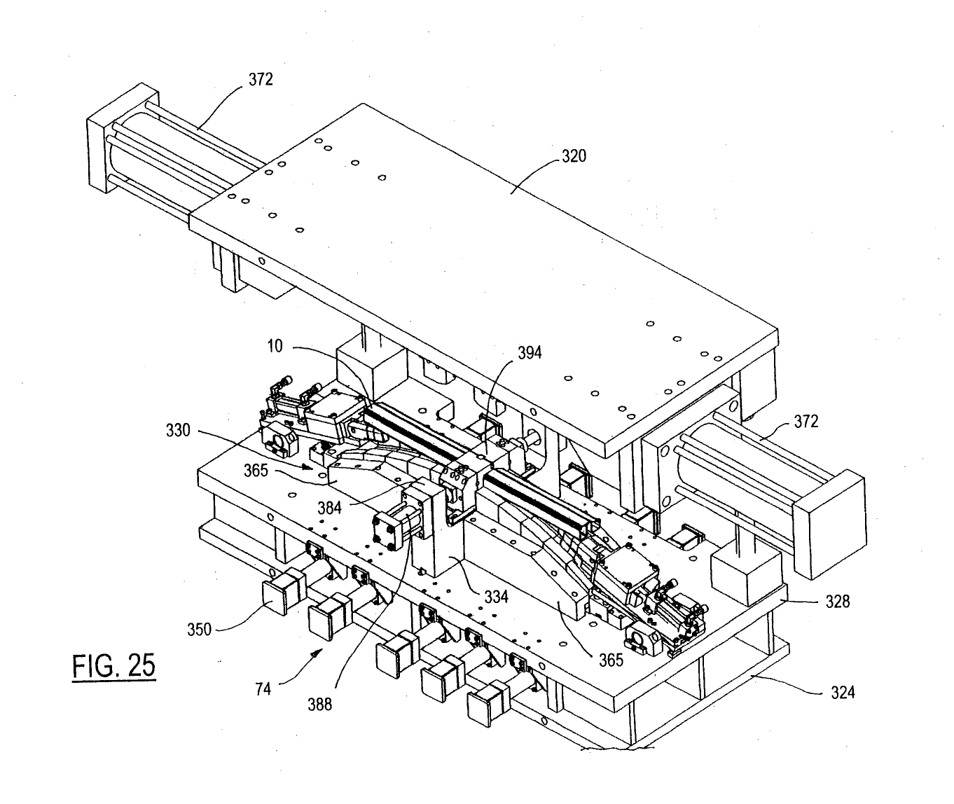

The robotic system 60 has a die set 74 as illustrated in FIG. 25 which is mounted on and secured to the lower stationary bed or platen 66 of the hydraulic press 62 as shown in FIG. 12.

The robotic system 60 further includes a gravity feed magazine loader 76 which has an emergency stop button 78. Located adjacent the magazine loader 76 and outside of the enclosure 72 is the palletizer or container 39 in which the straight tubular cross members 12 are located. A workman manually removes the straight cross members 12 from the palletizer 39 and places them on the magazine loader 76 as will be explained later in greater detail.

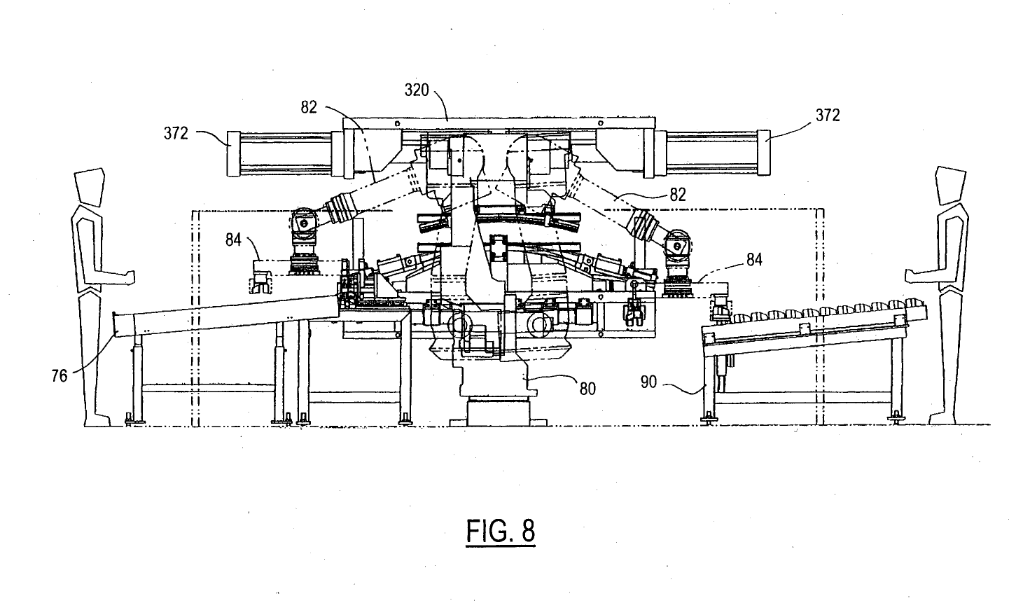

A robot 80 having an arm 82 with an end effecter 84 is illustrated in FIG. 8 and will be described in greater detail later on in the specification.

The robotic system 60 further includes an electronic checking apparatus 90 which is partially located inside the enclosure 72, with the exit end of the checking apparatus 90 extending through the enclosure 72 to permit a workman to remove the curved bumper 10 once it has been checked for accuracy purposes by the electronic checking apparatus 90. An emergency stop button 92 is provided to permit the workman to stop the electronic checking apparatus 90 should the occasion arise and for safety purposes. Located adjacent to the electronic checking apparatus is a reject station and table 94 where bumpers which have been rejected by the apparatus 90 are placed on the table 94 for further processing. The apparatus 94 measures the curved surfaces on the swept bumper bar and if it does not meet specification corrections are directed to the die set 74 to make the necessary adjustments.

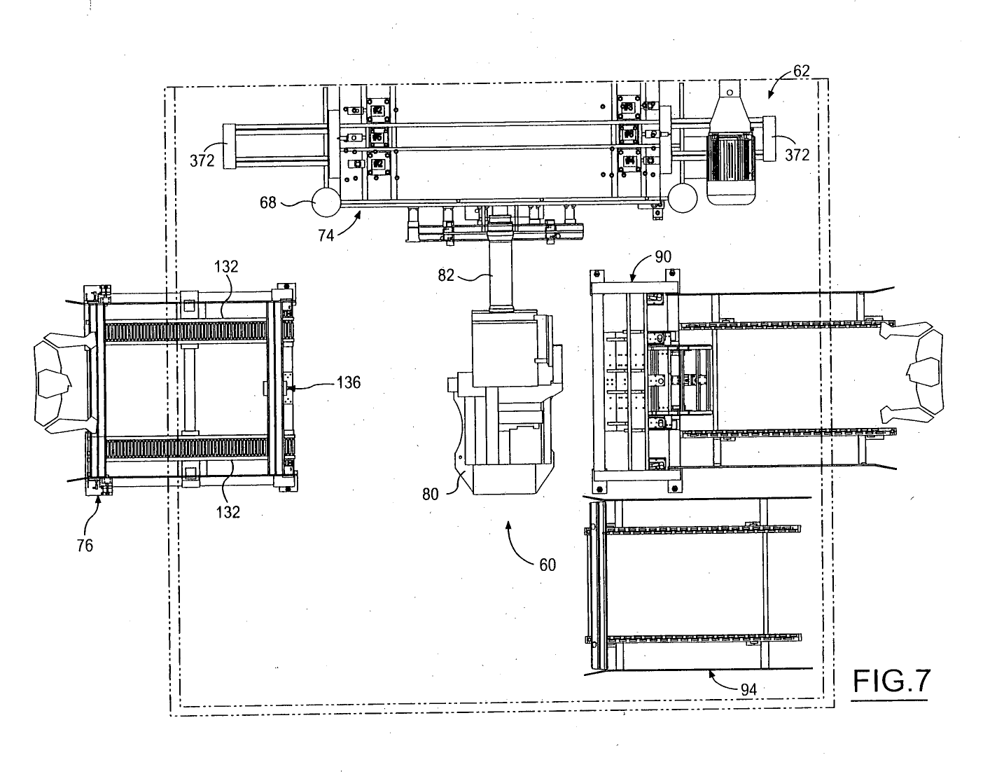

It should be noted that the robot 80 is interposed between the gravity feed magazine loader 76 and the electronic checking apparatus 90, with the robot 80 being located directly opposite the hydraulic press 62 and die set 74 as illustrated in the plan views of FIGS. 6 and 7. With such an arrangement the robot 80 has a rotational movement of greater than 180 degrees. It suffices to say at this time that the robot 80 is at home at the magazine loader 76 where the end effecter 84 of the robot 80, when activated, picks up a straight tubular cross member 12 with a first pair of grippers 86 and is thereafter rotated to the hydraulic press 62 where a second pair of grippers 88 removes the curved bumper 12 from the press 62 after it has been formed therein. While the robot 80 remaining at the press 62 the end effecter 84 is rotated 180° to place the straight tubular cross member 10 in the press 62. Thereafter, the robot 80 is rotated 90° to the electronic checking apparatus 90 where the curved bumper 12 is placed in the apparatus 90 where the curved surface on the bumper is measured along the length thereof. The robot 80 remains at the checking apparatus 90 until the measurements have been made which takes only a second or two. If the measurements of the bumper 12 meet specification the hydraulic press 62 recycles. If inaccurate measurements are found in the bumper, the press 62 is prevented from cycling and the robot 80 picks up the rejected bumper at the checking station 90 and transfers it to the reject table 94. Almost simultaneously corrections are sent by apparatus 90 to the die set 74 to make the required adjustments. Thereafter, the press 62 recycles. The robot 80 rotates greater than 180° from the reject station to the magazine loader 76 where it picks up a straight bumper bar 12 and moves it to the hydraulic press 62 and die set 74 where the procedure heretofore briefly described is repeated.

### Gravity Feed Magazine Loader

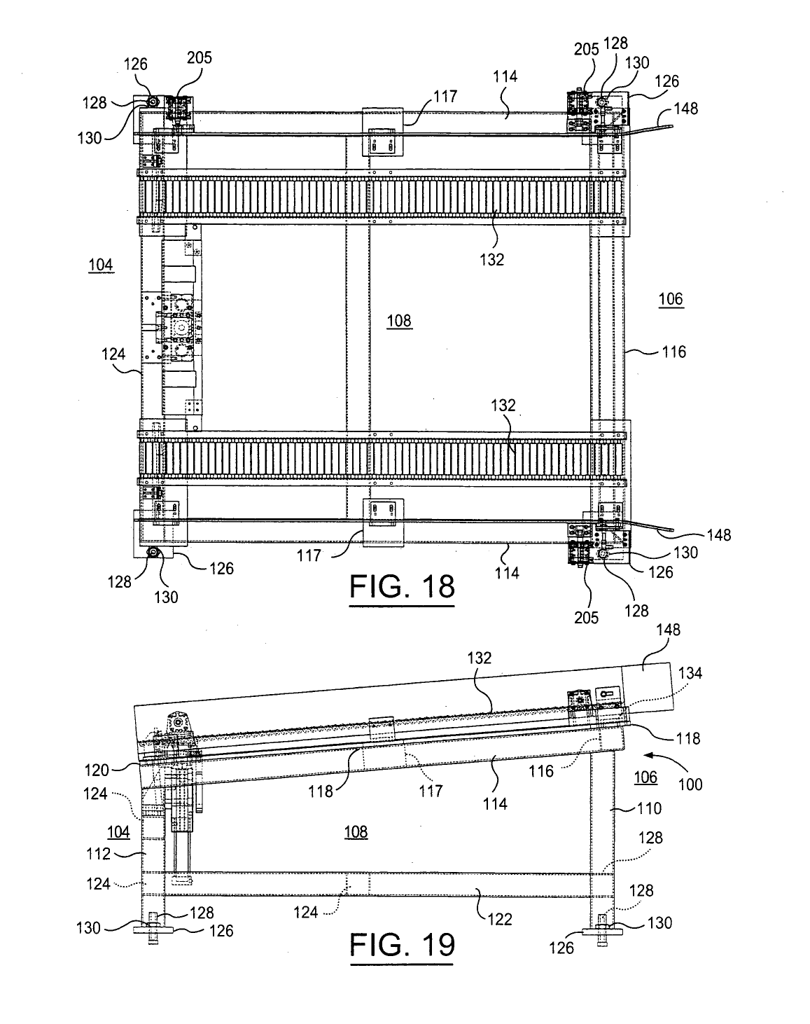

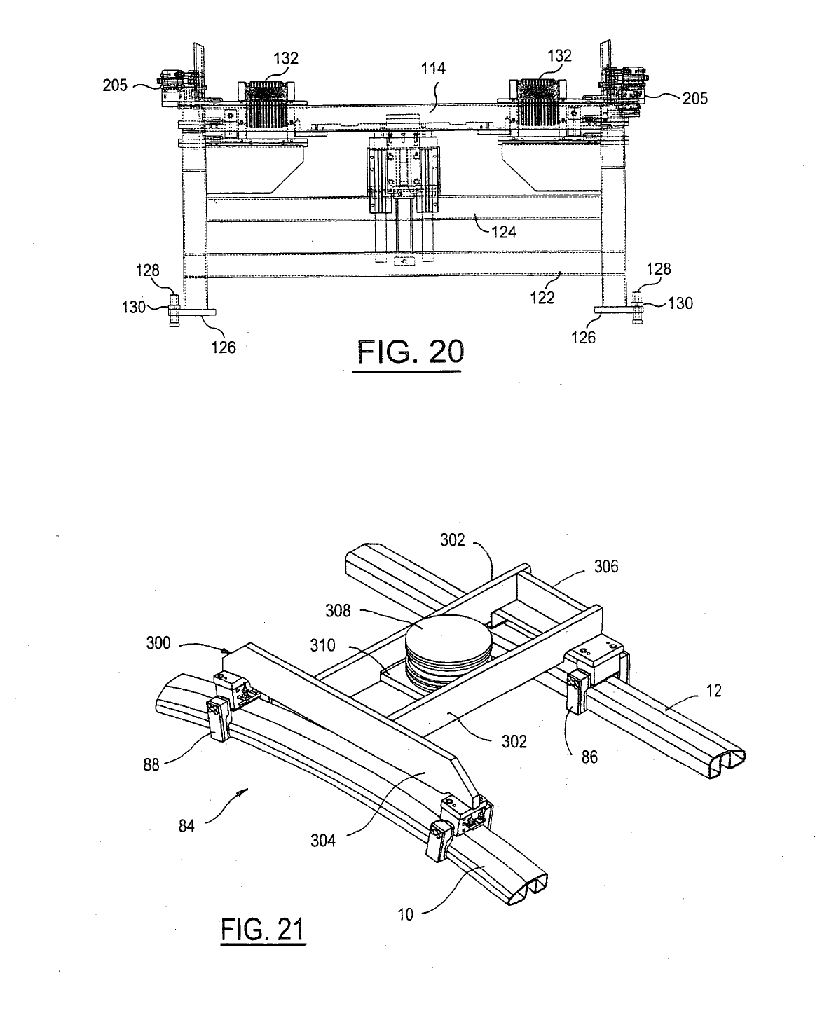

The gravity feed magazine loader 76 of FIGS. 18-20 has an elongated frame 100 with a longitudinal extending center axis 102. The frame 100 has a front 104, a back 106 and a pair of sides 108. The frame 100 has two pairs of legs including a front pair of legs 112 and a back pair of legs 110 at the corners of the frame 100. The legs 110 at the back 106 are longer than the legs 112 at the front 104 of the frame 100. The upper ends of the legs 110, 112 at each side 108 are connected by outboard tubular side members 114. The ends of the side members 114 at the back 106 are connected by an upper cross member 116. An intermediate cross member 117 connects intermediate portions of the parallel side members 114 to provide further support for the frame 100.

The frame 100 further includes on the top surfaces of the side members 114 and cross members 116 and 117 two pairs of support plates 118. In addition, a pair of support plates 120 are provided on the top surface of the side members 114 at the front 104 of the frame 100. Support plates 118 and 120 are of generally the same size, with the support plates of each pair being transversely aligned and spaced laterally apart. Each pair of support plates 118, 120 are arranged parallel to the other support plates as illustrated in the drawings.

The frame 100 is further reinforced at the lower extremity by a pair of lower side members 122 and by lower cross members 124 provided at the front 104, rear 106 and near the center thereof.

The bottom of the legs 110, 112 are each provided with a generally rectangular floor plate 126 which carries an adjustment jack screw 128 and threaded nut 130 for leveling the frame 100 with respect to the ground surface and to prevent movement of the loader 76 when subjected to vibrations.

A pair of roller conveyors 132 are mounted on the support plates 118 and 120. The roller conveyors 132 are arranged parallel to the longitudinal axis 102 and are spaced inwardly from the sides 108 of the frame 100. The conveyors 132 are Metsgar brand of conveyors. The conveyors 132 are secured to the plates 118, 120 by fasteners 134. Each conveyor 132 consists of a pair of spaced apart channel members 133 which rotatably carries the rollers 131. The opposing webs 135 of the channel members 133 support the ends of the rollers 131.

A vertically mounted lift device or PHD slide 136 is secured to the front 104 of the frame 100 between the parallel outboard side members 114. The lift device 136 includes a pneumatic cylinder 138 with a piston 140 and a rod 142 moveable therein. The piston rod 142 has an end extending outwardly from the cylinder 138. A platform 144 located at the front 104 between the conveyors 132 is mounted over the slide 136 and is secured to the outer end of the rod 142. The upper surface of the platform 144 is at approximately the same elevation as the front end of the roller conveyors 132. As a workman loads beams 10 on the roller conveyors 132 at the rear 106 the straight roll-form bumper bars 10 roll down the roller conveyors 144 towards the front 106 where the leading bumper bar 10 comes to rest on the platform 144. The platform 144 when energized by the pneumatic cylinder 138 lifts the straight bumper bar 10 vertically upwardly at the front 104.

Mounted on the top frame 100 are a pair of laterally spaced apart side guards 146 which are generally located above the outboard side members 114. The purpose of the spaced apart side guards 146 is to assist in retaining the straight roll formed bumper bars 10 therebetween as the bars 10 progress along the roller conveyors 132 from the back to the front of the apparatus 76. The side guards 146 at the back 106 of ends 148 are flared outwardly and away from one another as illustrated in the drawings for the purpose of assisting the loading of the straight bumper bars 10 on the roller conveyors 132.

A pair of extra low profile air cylinders 150, 152 are mounted on the sides 108 near the rear 106. The air cylinders 150, 152 are mounted outboard of the side guards 146 adjacent the flared ends 148. The air cylinders 150, 152 are each provided with a pair of grabbers to assist in locating the bumper bar in proper orientation on the conveyors 132.

Another extra low profile cylinder 154 is provided outboard on one side 108 near the front 104. The rod of cylinder 154 is provided with a pair of grabbers for engaging the outer surface of the bumper bar and assist in locating same in the proper position. An electrical proximity switch 156 is provided at the front which, when activated, signals the robot 80 that the bumper bar 12 is ready to be moved by the robot 80 to the hydraulic press 62 and die set 74.

The angle of inclination of the side members 114 and roller conveyors 132 is approximately 10 degrees to permit the weight of the bumper bars 10 to gravity feed the bumper bars 10 from the back 106 to the front 104.

### Electronic Checking Apparatus

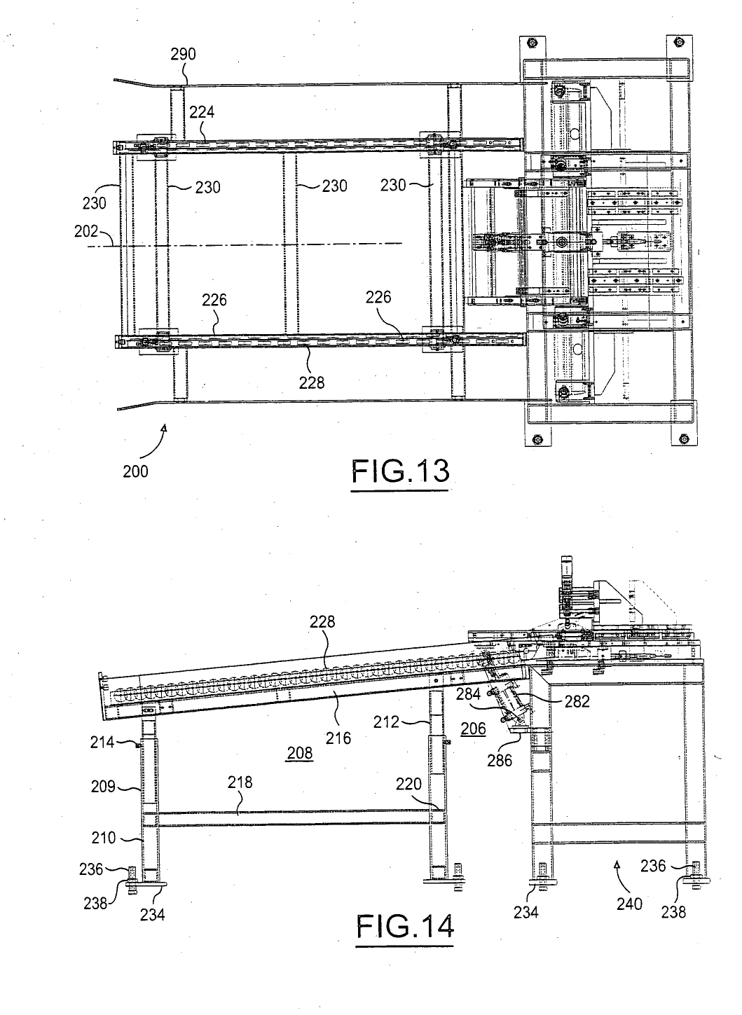

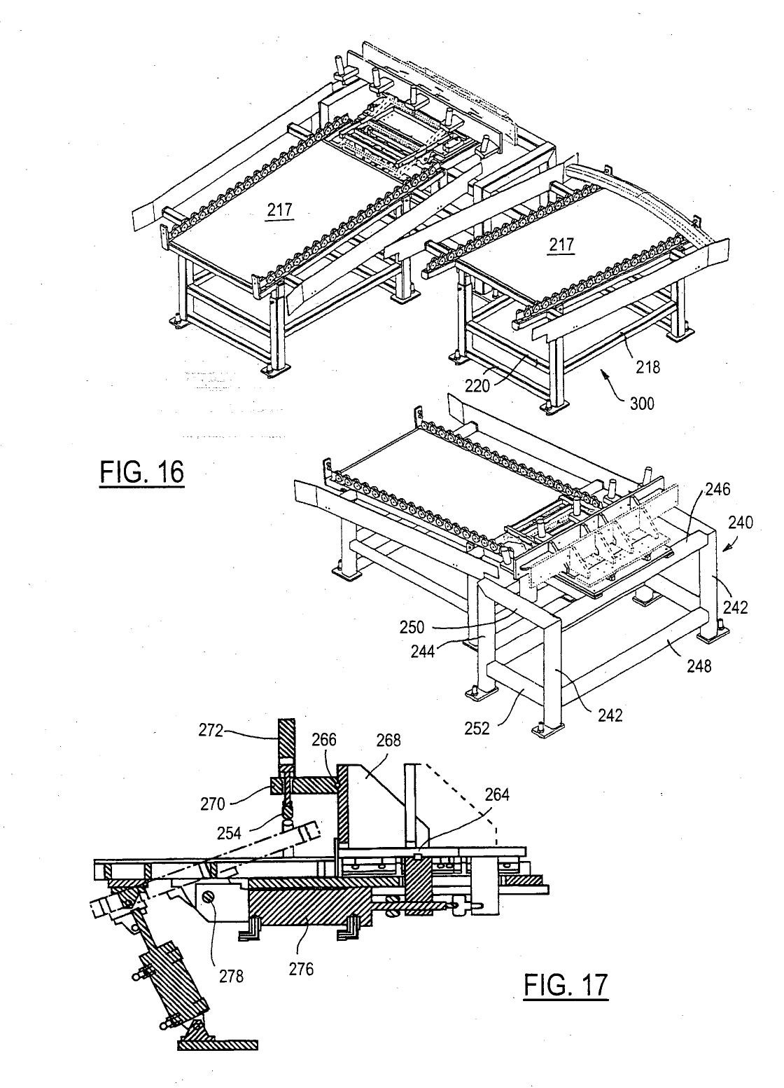

The electronic checking apparatus of FIGS. 13-17 inclusive has an elongated first frame 200 provided with a longitudinally extending axis 202. The first frame 200 has front 204, a back or rear 206 and a pair of sides 208. The frame 200 includes a pair of front legs 210 and a pair of rear legs 212. Each leg 210, 212 is made from-a pair of telescopically tubular members with the upper member sliding within the lower member and held in adjusted position by an adjustment screw or bolt 214. The frame 200 further includes a pair of elongated side members 216. A top plate 217 spans the side members 216. The upper ends of a pair of legs 204 and 206 at one side 208 of the frame is connected to the elongated side member 216. The lower extremity of the frame 110 is reinforced by the provision of lower tubular side members 218 and by a pair of lower cross members 220 at the rear 206 and at the front 204. Mounted on the top surface of the frame 200 above the elongated side members 216 is a pair of wheel rail conveyors 224. Each conveyor 224 has an upstanding flange 226 on which is mounted on each side thereof a plurality of longitudinally spaced wheels 228. The wheels 228 on one side of the elongated flange 226 are staggered from the wheels 228 on the opposite sides of the flange 226, as best illustrated in FIG. 13. The elongated side members 216 are connected by plurality of upper cross members 230 reinforcing the support of the wheel conveyors 224.

It should be noted that the legs 210 and 212 are inwardly set from the corresponding ends of the elongated side members 216. Thus the side members 216 extend forwardly beyond legs 210 and rearwardly beyond the legs 206, as best illustrated in FIG. 14. Each leg 210, 212 is provided with a leveling foot 232 consisting of a generally flat plate 234 carrying an adjustment screw 236 and a threaded nut 238.

A second frame 240 is located behind the rear legs 212 at the rear 206 of the first frame 200. The second frame 240 is of rectangular configuration and has a pair of front legs 242 and a pair of rear legs 244 which are opposite the rear side 206 of the first frame 200. The upper ends of the front legs 242 are provided with an upper cross member 246 and a lower cross member 248. Each pair of legs 242 and 244 are provided with an upper cross member 250 and a lower cross member 252. The top plate 217 is mounted on the frame support.

An ejector and slide mechanism 260 is mounted on the second frame 240. The ejector and slide mechanism 260 has an open position and a closed position. The slide 262 of the mechanism 260 is moveable on the second frame 240 for receiving and positioning a swept bumper bar.

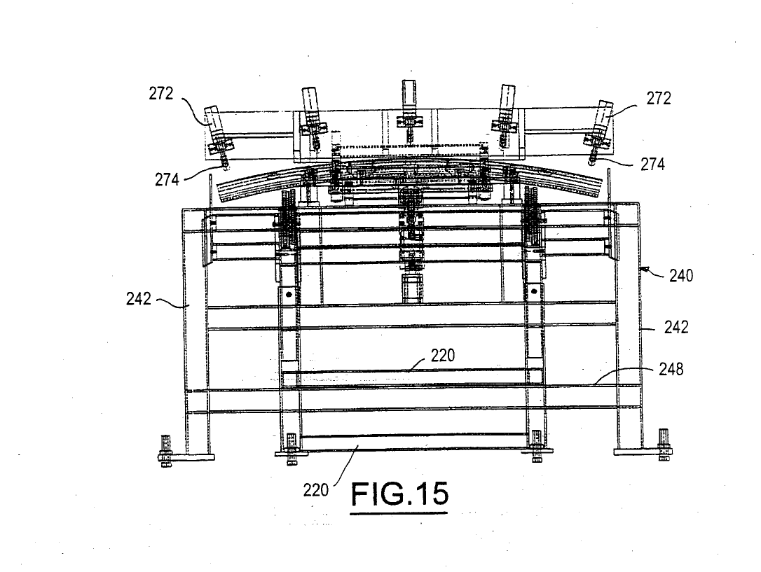

The ejector and slide mechanism 260 includes a horizontal support 264 and a vertical support 266. A series of gusset plates 268 reinforces the vertical support 266. Extending forwardly from the front side of the vertical support 266 are five spaced apart cylinder supports 270. The supports 270 are arranged in the form of an arc as best illustrated from FIG. 15. Each support 270 carries an air cylinder 272 with a plunger 274 extending downwardly. The air cylinders 272 are Parker brand stainless steel body air cylinders, SRX series w/plug in. An air cylinder 276 is attached to the bottom of the slide mechanism 260. The cylinder 276 provides the actuating force for moving the slide 262 with the air cylinders 272 thereon over the curved bumper in order to determine the measurements of the swept bumper. A Parker brand two way cylinder 282 has a cap end with a clevis mount. The cylinder 282 is pivotally mounted at 284 to a bracket 286 carried by the second frame 240 (FIG. 14). The cylinder 282 is connected to the ejector mechanism for raising and lowering same. With a curved bumper in position in the electronic checking apparatus 90, the fixture is moved over the bumper and the five cylinders 272 and plungers 274 are brought into contact with the curved bumper surfaces of the swept bumper bar. The probes 276 sends or transmit the electronic data to a recording station where the information is processed and adjustments are automatically made to the die set 74.

The electronic checking apparatus 90 further includes a pair of longitudinally spaced apart side guards 290 which are mounted at the top of the first frame 200 outboard of the pair of longitudinally extending wheel rail conveyors 222 and 224. The side guards 290 at the front of the first frame 200 have the ends 292 flared outwardly, away from one another as illustrated in FIG. 13.

The bottom surfaces of the legs 210, 212, 242 and 244 of both the first and second frames 200, 240 are provided with base plates 234. As mentioned previously, each base plate 234 has a vertically adjustable screw jack 236 and threaded nut 238 for providing a means for leveling the frames 200, 240 and for preventing movement of the apparatus 90 when subjected to vibrations.

The ejector mechanism 260 is pivotally mounted at the top of the second frame 240, with the mechanism 260 when in an open position preventing the bumper bar from proceeding along the wheels 228 to the exit end thereof. If the measurements of the swept bumper are not accurate, then the bumper may be moved by the robot 80 from the electronic checking apparatus 90 to an adjacent reject table or station 298 or permitted to drop through the opening provided by the ejector mechanism into the space below the apparatus. The reject table or station 298 is identical in construction to the first frame 200 and wheel rail conveyors 222 and 224. Reject table or station is retained within the confines of the safety enclosure to prevent the operators from unloading a reject bumper without having first entered a keyed door.

### End Effecter

The robot 80 is a MOTORMAN™ brand robot, with a specially designed end effecter 84 which serves as a double handler of parts. The end effecter 84 can carry one straight bumper beam 12 and one curved bumper 10 as will appear from a reading of the specification. The robot 80 is rotatable throughout more than 180° and is located within the enclosure 72 in the space between the gravity feed magazine loader 76 and the electronic checking apparatus 90, in front of the hydraulic press 62 and die set 74.

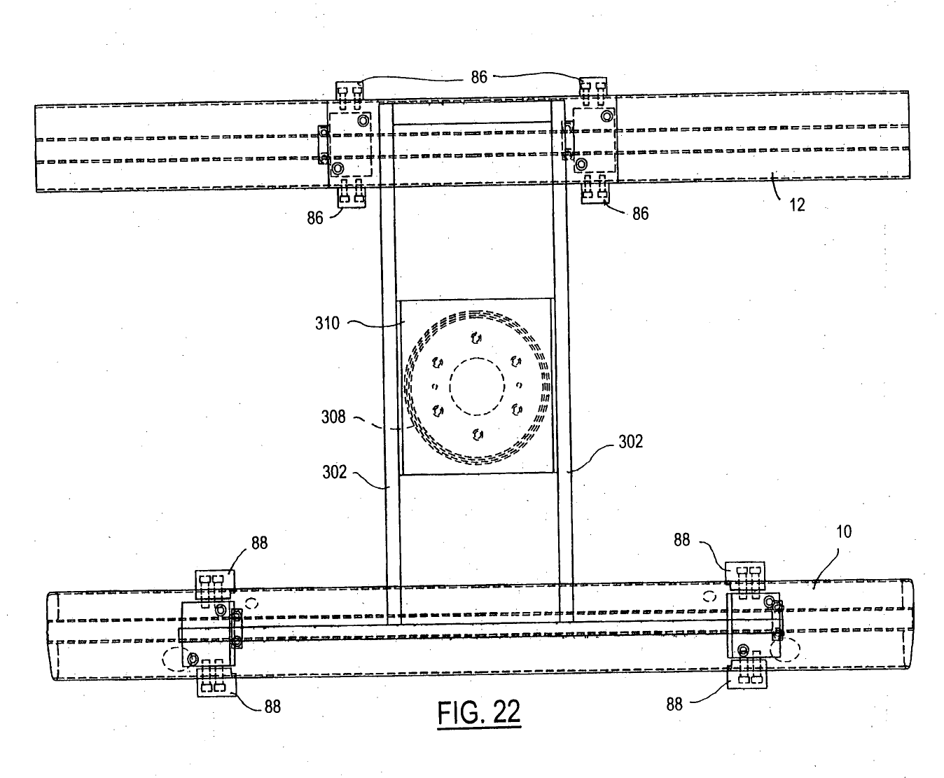

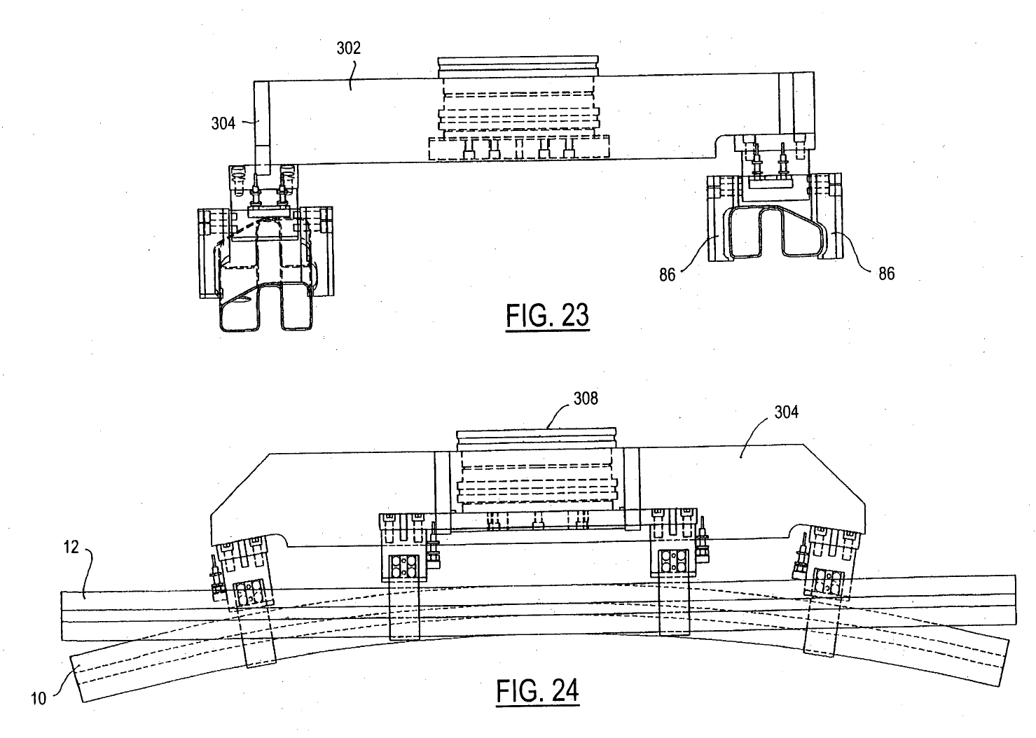

The end effecter 84 as best illustrated in FIGS. 21-24 inclusive has a frame 300 having a pair of spaced apart parallel side members 302 and a gripper support member 304 extends perpendicular to the side members 302 at one end thereof and is secured thereto. A cross brace 306 is located between and is secured to the other end of the side members 302. A robot clutch assembly 308 is located in the space between the spaced apart side members 302 and is mounted on a plate 310 which is between the side members 302. The construction of the clutch assembly 308 is disclosed and described in U.S. Pat. Nos. 4,717,003 and 4,848,546. The electrical wiring and connections for the robot 80 are directed through the standard robot clutch connection 308 as is well known in the art. The first pair of grippers 86 are spaced closer together than the second pair of grippers 88 in order to pick up the straight roll formed bar member 12. The second pair of grippers 88 are arranged to pick up the curved bumper 12 as mentioned previously. Each pair of grippers 86, 88 consists of a pair of spaced apart elements having curved surfaces adapted to grip the curved surfaces on the bumper bar.

### Die Set

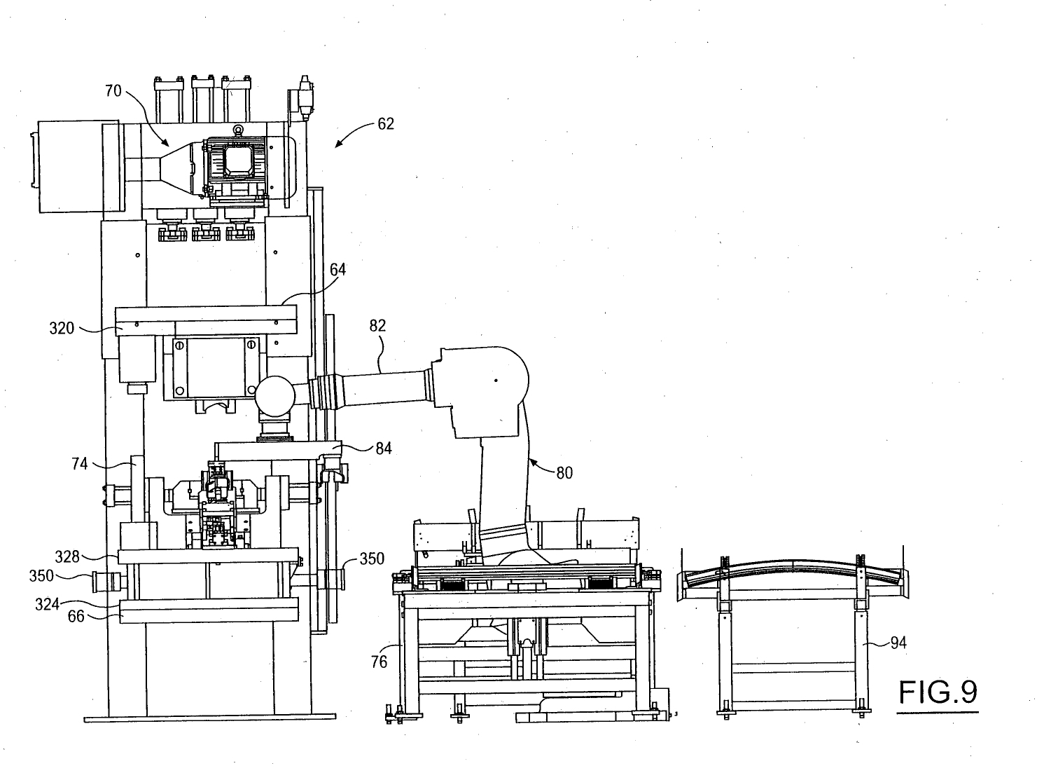

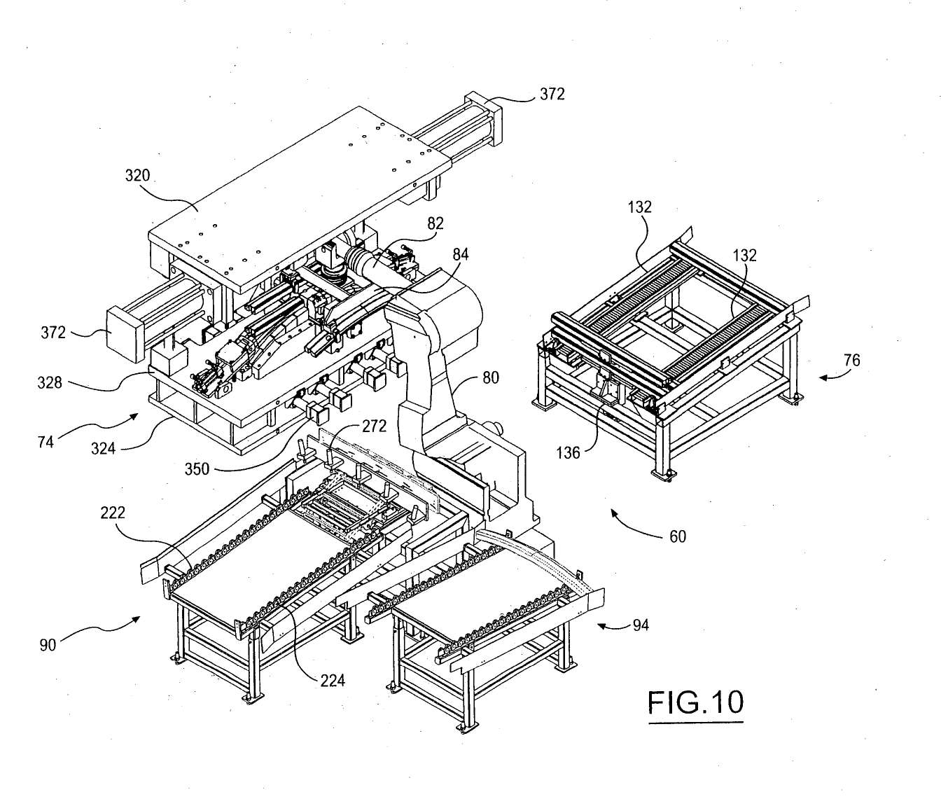

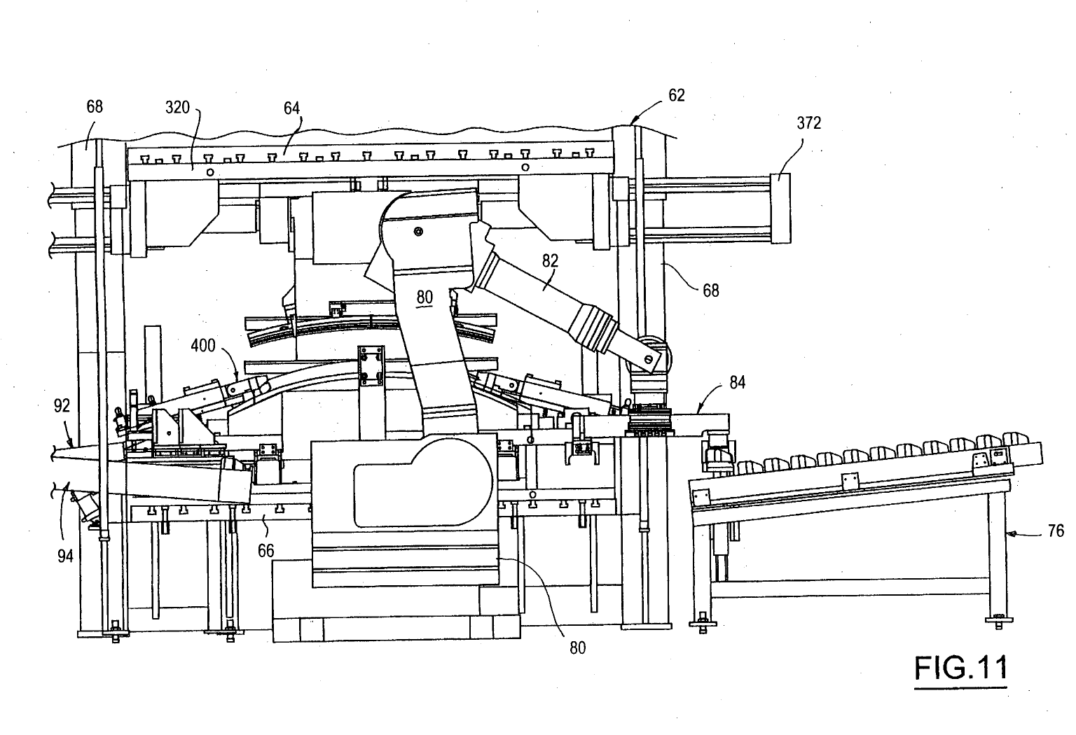

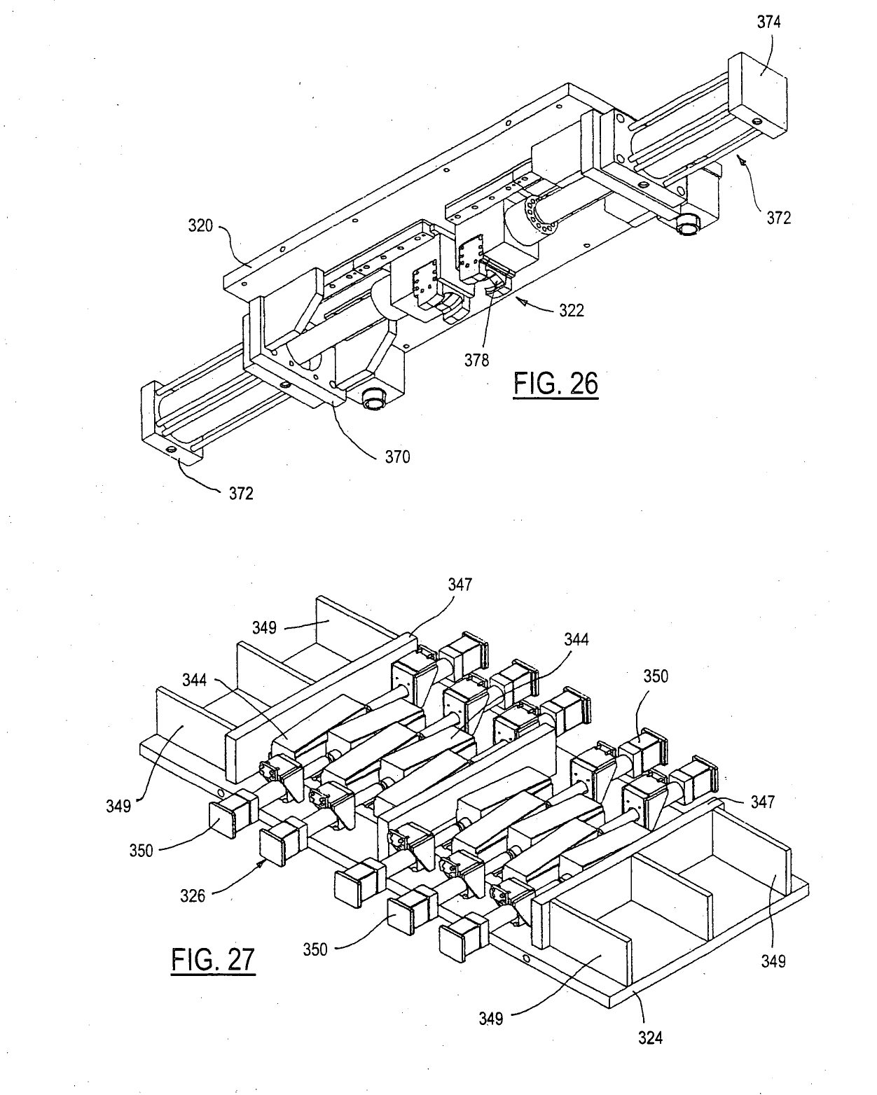

The die set 74 as illustrated in FIGS. 25-35, inclusive, includes an elongated upper plate 320 which is attached to the upper movable press ram or platen 64 as illustrated in FIGS. 9 and 12. The upper plate 320 supports the top tooling 322 (FIG. 26). The die set 74 further includes an elongated lower plate 324 for supporting the wedge adjustment tooling 326 (FIG. 27).

An elongated intermediate plate 328 is interposed between the top die tooling 322 and the wedge adjustment tooling 326 for supporting the bottom die tooling 330. The upper plate 320 is provided at the rear corners thereof with guide bushings 319 which travel or guide on the upstanding guide posts 321 fixedly carried by the intermediate plate 321 during the crossing of the die by the press 62.

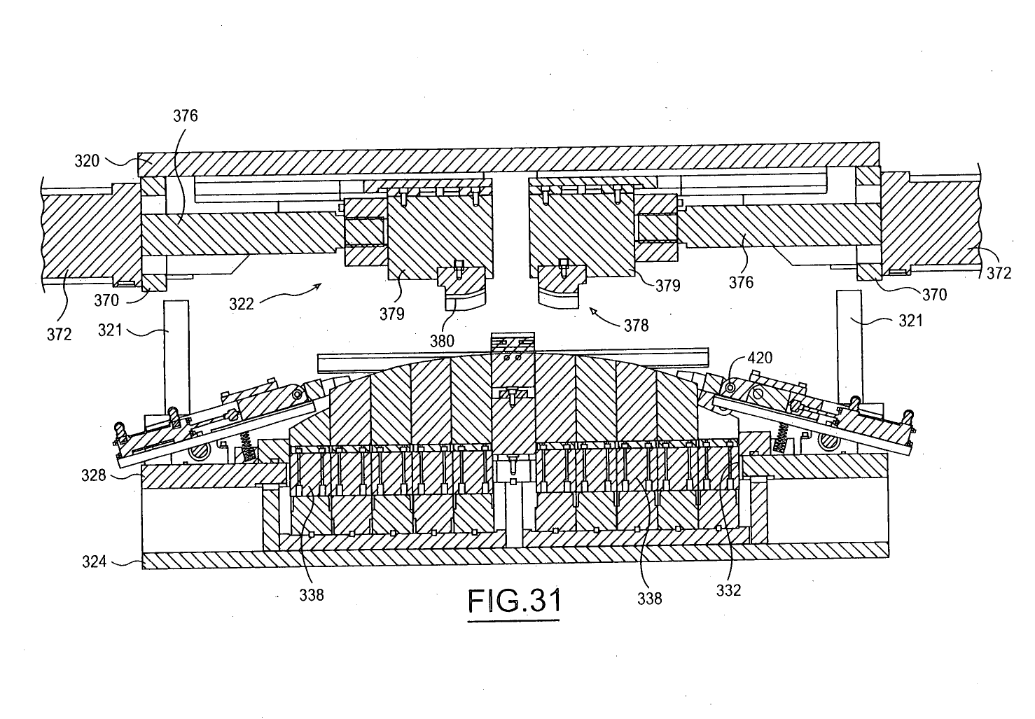

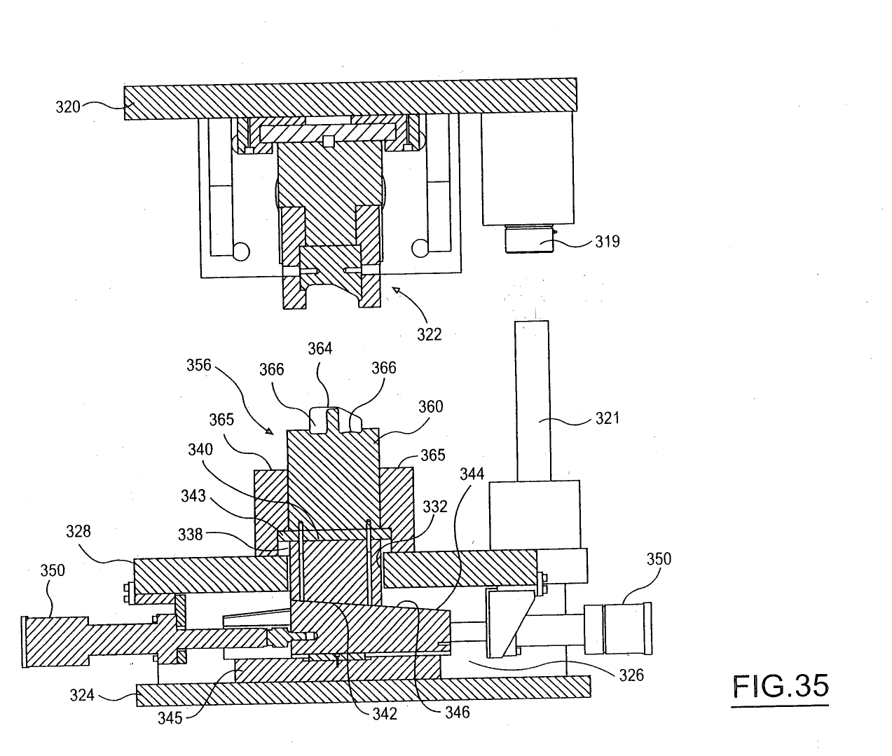

An opening 332 is provided in the elongated intermediate plate 328 (FIGS. 31 and 35). A center pedestal 334 is located in the center opening 332, with the bottom surface 336 of the center pedestal 334 in contact with and supported by elongated intermediate plate 328. A series of transfer blocks 338 are located in the center opening 332 of plate 328 on opposite sides of the pedestal 334. Each transfer block 338 has a top surface 340 which is flat and a bottom surface 342 which is inclined or tapered, as best illustrated in FIG. 35. A shim or plate 343 is located above and in contact with each top surface 342.

A series of wedges 344 are located on opposite sides of the center pedestal 334, one wedge 344 for each of the transfer blocks 338. The wedges 344 are movable on plates 345 located on the lower plate 324. The top surface 346 of each wedge 344 is tapered and is engagable with the opposing tapered bottom surface 442 of the transfer block 338. The wedge tooling 326 includes reinforcing elements 347 and 349 at the outer ends of the lower plate 324 on opposite sides of the wedges 344 as shown in FIGS. 27 and 29.

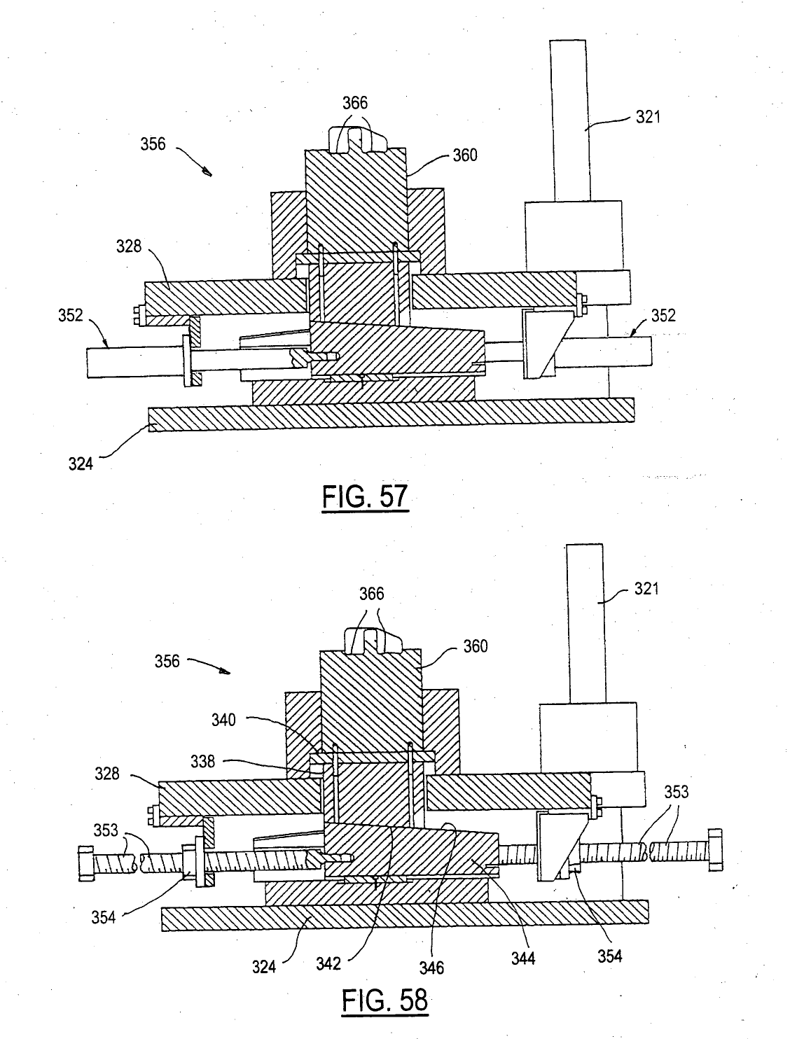

Actuating means are connected to each wedge 344. Actuating means may be in the form of electronic servo ball screw motor 350, as illustrated in the preferred embodiment. Alternate embodiments of the actuating means are illustrated in FIGS. 57 and 58 and include the use of hydraulic cylinders 352 in FIG. 57 and manually adjustable threaded rods or bolts 353 with adjustments nuts 354 in FIG. 58. The purpose of the actuating means is to adjust the position of the wedges 344 in order to accurately change the height or position of the die inserts 360 to be subsequently described.

It is best illustrated in FIGS. 27 and 29 where the electronic servo ball screw motors 350 are staggered with one ball screw motor being on one side of the wedge tooling and the adjacent or next servo ball screw motor 350 being on the opposite side.

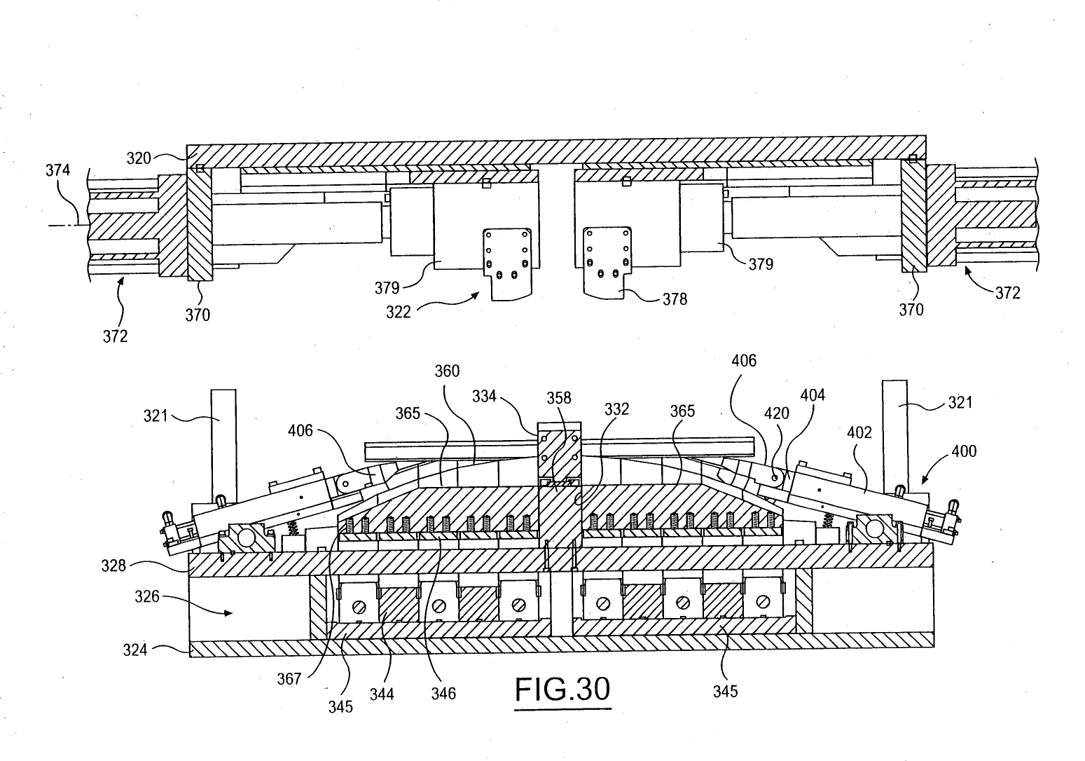

A contour cut male sweep mandrel 356 is mounted above the transfer blocks 338 and shims 343 as shown in FIG. 35. The mandrel 356 includes a series of vertically adjustable inserts 360 located on opposite sides of a support block 358. One insert 360 as shown in FIG. 35 overlies and is aligned with a corresponding plate 343, a transfer block 338 and the corresponding adjustment wedge 344. Opposite sides of the mandrel are provided with elongated side supports 365. A pair of springs 367 are interposed between the series of plates or shims 343 and the side supports 365 as illustrated in FIGS. 30, 32 and 33.

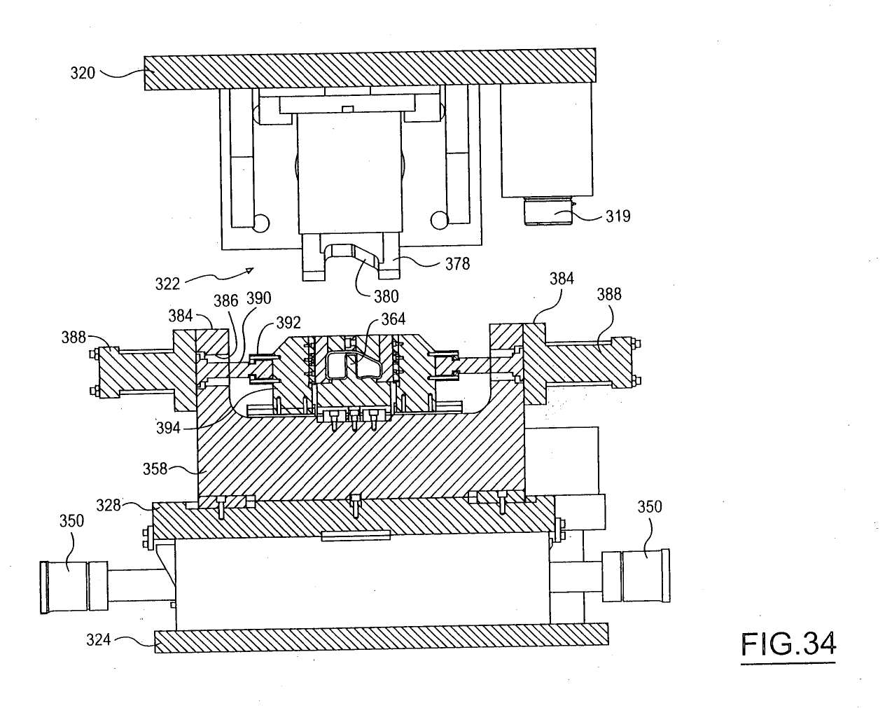

The top surfaces 362 of the inserts 360 of the mandrel 356 have an upstanding curve center support 364 (FIGS. 34 and 35). The upstanding center support 364 is located between a pair of elongated recesses 366 extending from one insert 360 at one end of the mandrel 356 to the insert 360 at the other end of the mandrel 356. The upper plate 320 is located above the mandrel 356 and overlies and is spaced from the intermediate plate 328, as illustrated in FIGS. 34 and 35.

The elongated upper plate 320 has on each end thereof a mounting bracket 370. The mounting brackets 370 extend downwardly, as illustrated in FIGS. 30-33. The upper top tooling 322 includes a pair of hydraulic cylinders 372 which are mounted outboard of the upper support plates 320 and are carried by the mounting brackets 370. The cylinders 372 have a common longitudinally extending axis 374. Each cylinder 372 has a shaft 376 extending inboard of the corresponding bracket 370 along the longitudinal axis 374 of the cylinders 372.

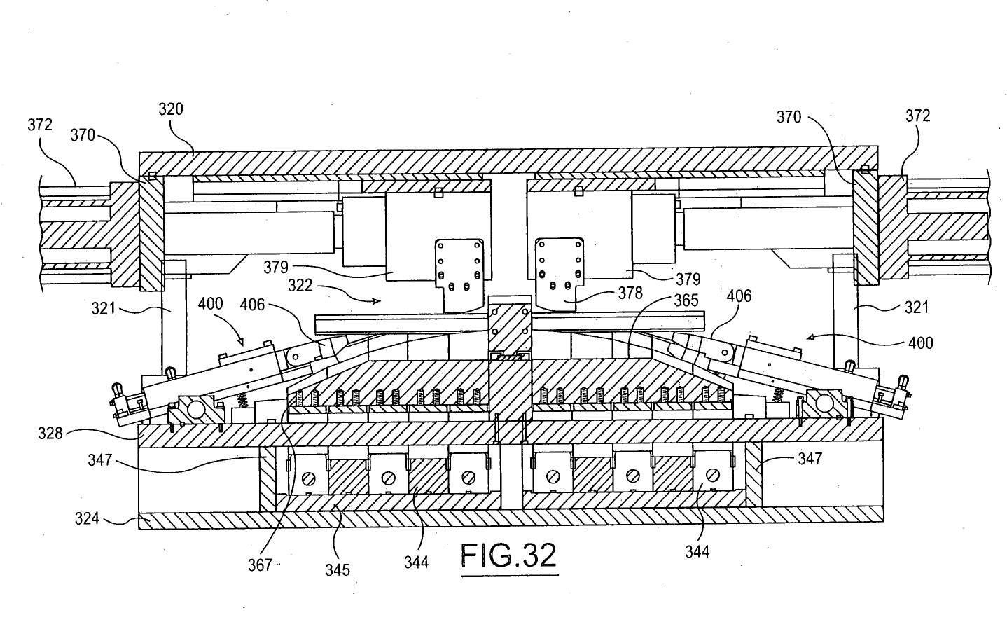

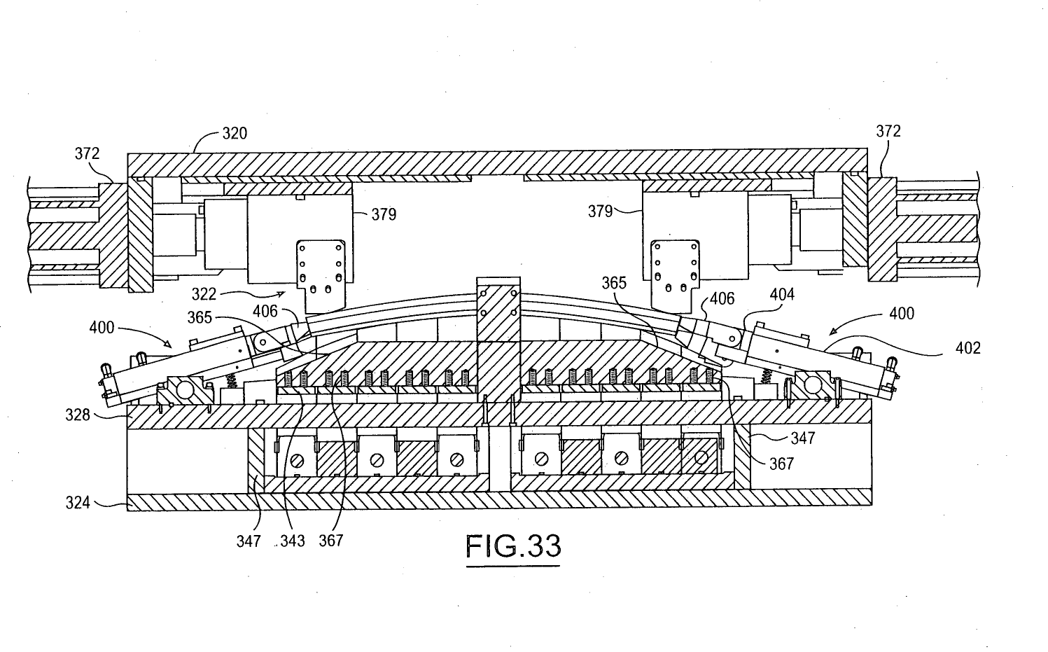

A pair of opposed wiper or formation blocks 378 are carried by the upper supports 379 attached to the shafts 376 of the cylinders 372. The formation blocks 378 are thus mounted above the male mandrel 356 and are moved in opposite directions by the opposing shafts 376 of the power hydraulic cylinders 372. The wiper blocks 378 have curvatures 380 corresponding to the profile of the bumper bar 12. Power or hydraulic cylinders 372 when energized move the wiper blocks 378 away from each other across the top surface of the bumper bar 12 towards the opposed ends of the mandrel 356 upon the cycling of the press, thereby moving the die set 74 from the position illustrated in FIG. 30 to intermediate positions illustrated in FIGS. 31 and 32, and finally, to the position illustrated in FIG. 33 where the wiper blocks 378 have moved completely across the top surface of the bumper bar to provide a radius curvature thereon.

The die set 74 has an equal number of inserts 360, transfer blocks 338 and wedges 44 on each side of the center block 358. The inserts 360 at each side of the centrally located support block 358 are of different heights, with one insert 360 adjacent to support block 358 being greater in height than the other insert. It should be appreciated that the inserts 360 can be replaced with inserts of other configurations so as to place a different curvature on a bumper without having to replace the entire die set 74. In addition, utilizing replaceable die inserts 360 permit rapid changeover from one production bumper to another, thereby resulting in savings in time, labor and material. Besides changing the inserts 360, it may be necessary to change the tooling and curvature on the upper wiper blocks 378.

Referring now to FIGS. 25 and 34 the centrally located center block 358 has a pair of upstanding flanges 384, each of which is provided with a center opening 386. A pair of hydraulic clamping cylinders 388 are provided. Each cylinder 388 has a piston and a rod 390 connected by a coupling device 392 to a corresponding clamping jaw 394 as illustrated in FIGS. 34 and 25. The tubular “B” shaped beam or bar 10 is placed on the mandrel 356 as illustrated in FIG. 25. The hydraulic cylinders 388 are actuated to close the clamping jaws 394 as shown in the figures.

In order to assist in the formation of the curved bumper 12, each end of the mandrel 356 is provided with a hydraulically operated stabilizer 400. The stabilizer 400 consists of a cylinder 402 having a piston therein and a rod 404. The rod 404 is connected to a specially designed formation plug tool 406, illustrated FIGS. 37-40 and operationally illustrated in FIG. 33.

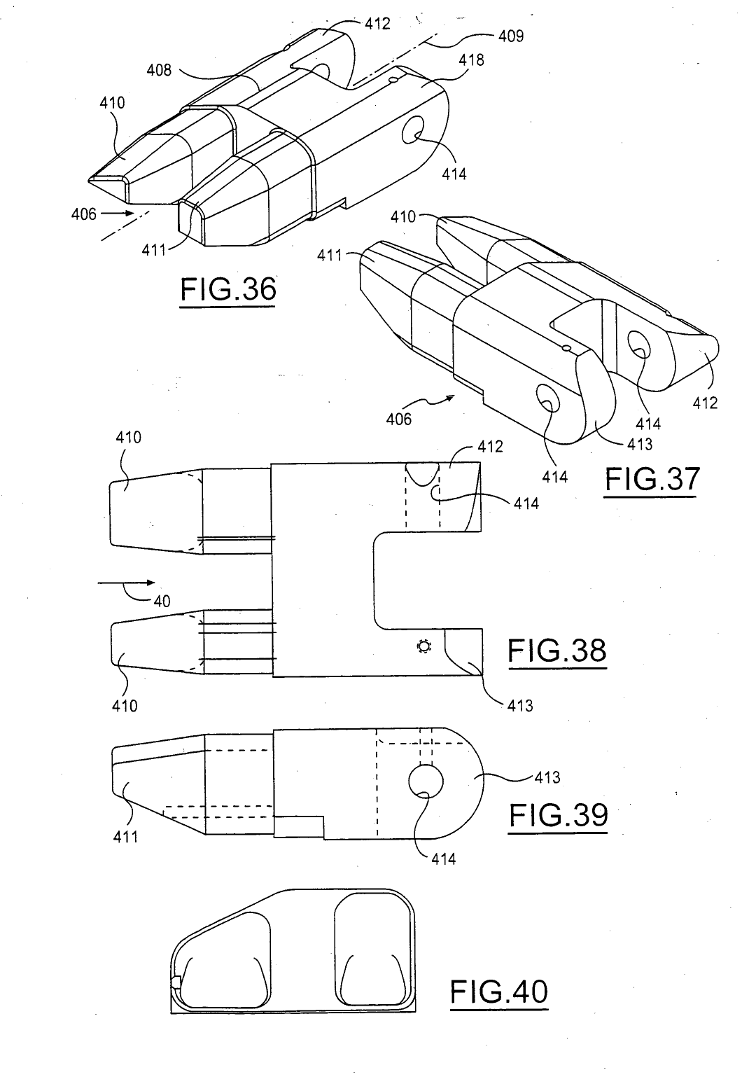

The formation tool 406 is best illustrated in FIGS. 36-40, inclusive. The tool includes a main body 408 having an axis 409. The body has a pair of forwardly extending, irregularly shaped prongs 410 and 411. The prongs are spaced on opposite sides of the axis 409 and are shaped and configured to fit within the ends of the “B” shaped cross member 10. The body 408 further includes a pair of rearwardly extending flanges 412 and 413 which are spaced on opposite sides of the axis 409. The flanges 412, 413 are provided with aligned apertures or holes 414. The tool 406 is attached to the rod 404 of the cylinder 402 by a pivot pin 420 shown in FIGS. 31 and 32. The plugs 410, 411 have various flat and curved surfaces designed to fit within and to conform to the “B” shaped section of the cross beam 10.

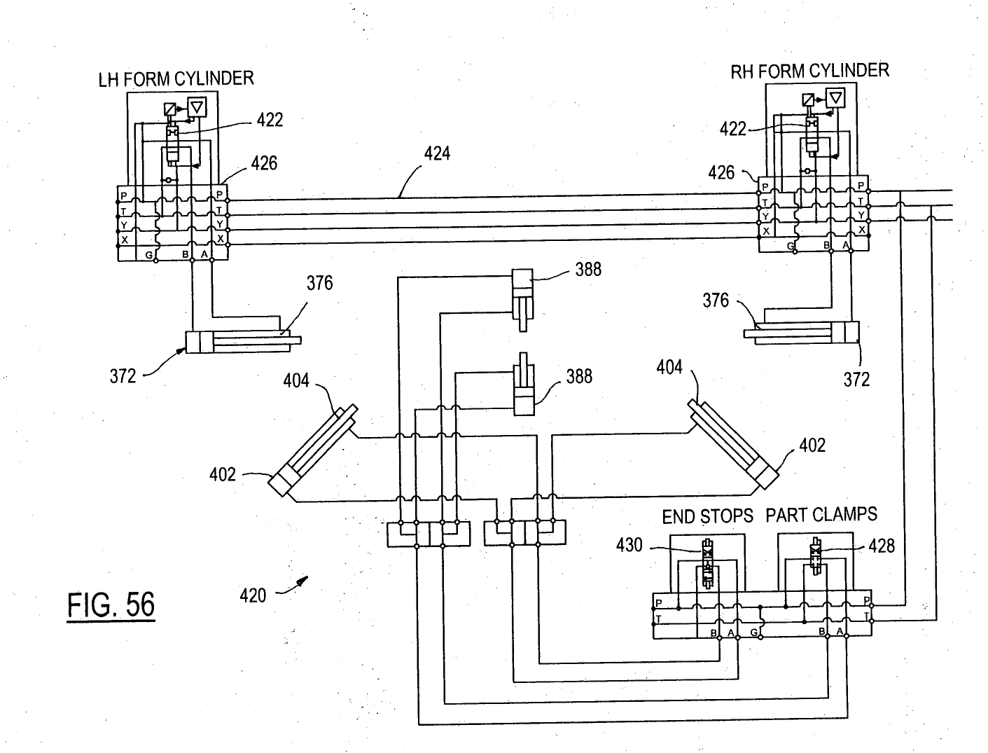

The hydraulic circuit for the various cylinders is designated by the numeral 420 in FIG. 56. The circuit 420 includes the upper tooling cylinders 372, the plug formation cylinders 402 and the clamping cylinders 388 for holding the bumper or beam 10 in the die set 74. A two-stage proportional valve 422 and a high flow single station manifold 426 are provided for each cylinder 372 of the top tooling 322. Various ports of the component parts are connected by hydraulic lines 424.

The center hydraulic cylinders 388 for clamping the tubular bar or beam 10 in the die set 74 are connected to a two-position detent directional control valve 428. The hydraulic cylinders 402 have rods 404 which are attached to the formation tools 406. A three-position directional control valve 430 is interposed in the hydraulic lines for directing hydraulic flow between the cylinders 402 and the hydraulic source.

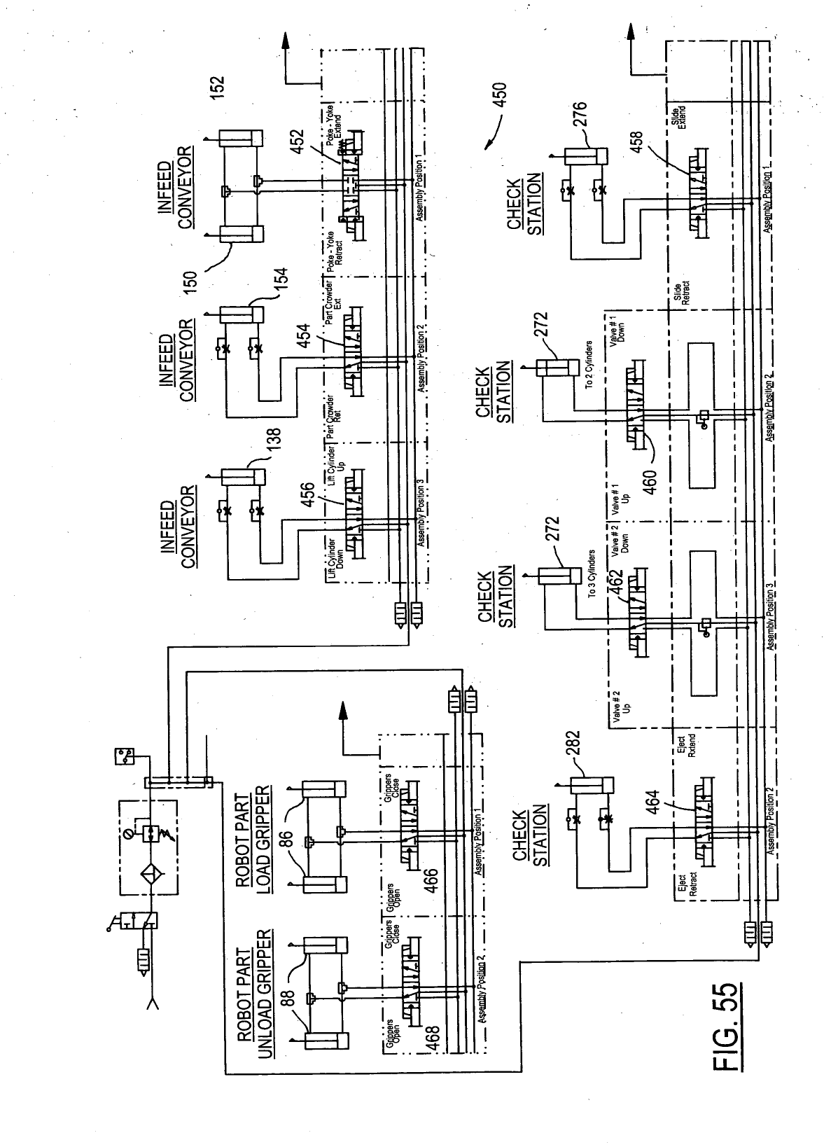

The infeed conveyor 132 of the gravity feed magazine loader 76 has a number of pneumatic cylinders 138, 154, 150 and 152 which are illustrated in FIG. 55 as part of the pneumatic circuit 450. The rear air cylinders 150 and 152 are connected to a direction control valve 452. The front air cylinder 154 is connected to the directional control valve 454. The cylinder 138 of the lift device 136 located at the front of the gravity feed magazine loader 76 is connected to a directional control valve 456 and moves up or down. The cylinders and valves just described are connected to a pneumatic source as is well known in the art.

The electronic checking apparatus 90 connected to the lower portion of FIG. 55. The cylinder 276 is a directional control valve 458 for directing the slide or carriage 262 to extend or retract. The slide 262 carries the five air cylinders 272 and corresponding plungers 274 which contact the top surface of the curved bumper 10 at the checking station. Two of the five cylinders 272 are connected to a directional control valve 460 while three of the five cylinders 272 are connected to a directional control valve 462. Energization of the cylinder 276 will extend or retract the slide 262. The good part eject cylinder 282 is connected to a directional control valve 464.

The first and second pairs of grippers 86 and 88, discussed previously, are included in the pneumatic circuit 450 of FIG. 55. The grippers 86, 88 have open and closed positions and are operated by pneumatic cylinders. The first pair of grippers 86 include pneumatic cylinders which are tied into a directional control valve 466, while the pneumatic cylinders of the second pair of grippers 88 are connected to the directional control valve 468. The pneumatic cylinders of the grippers 86, 88 are actuated to open the grippers and to close the grippers with respect to the bumper.

### Electrical Power Distribution Circuits

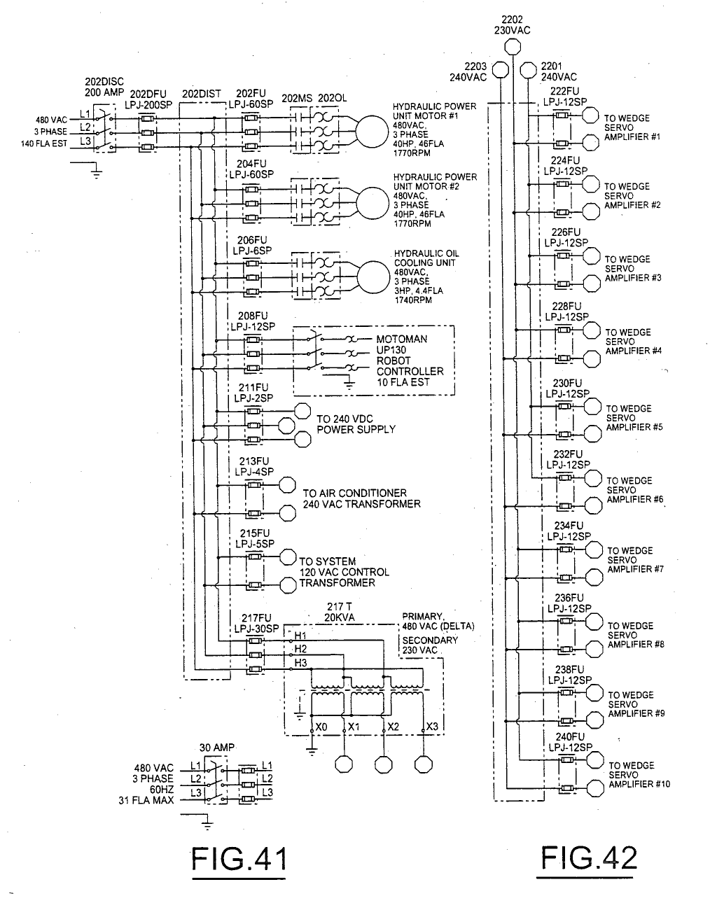

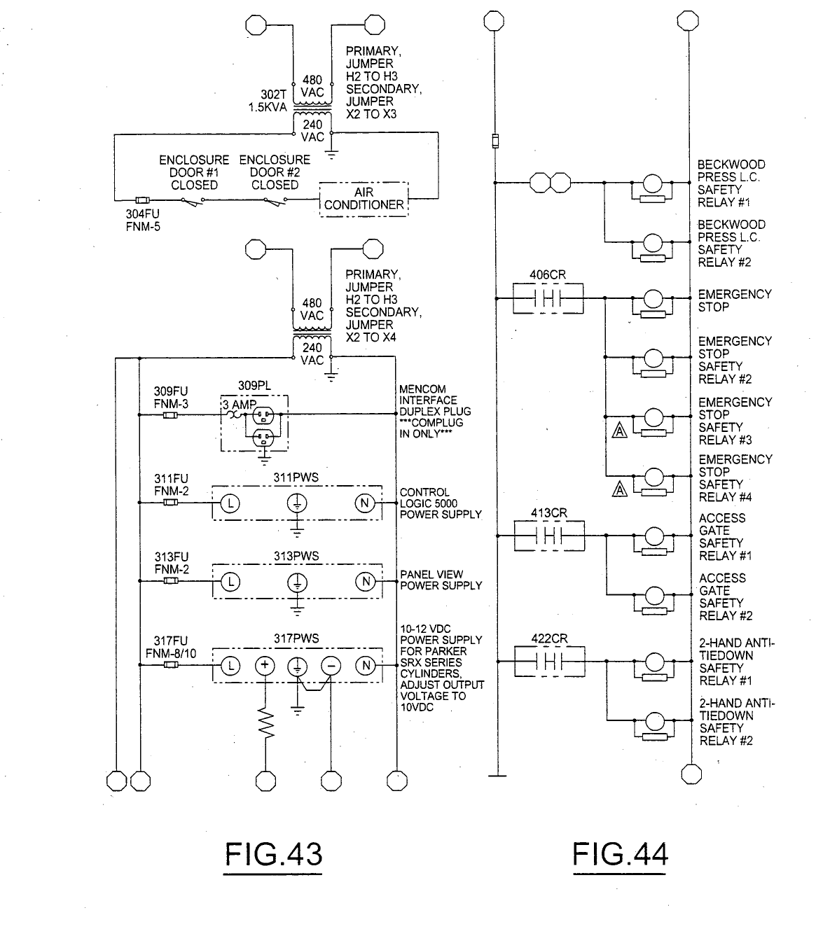

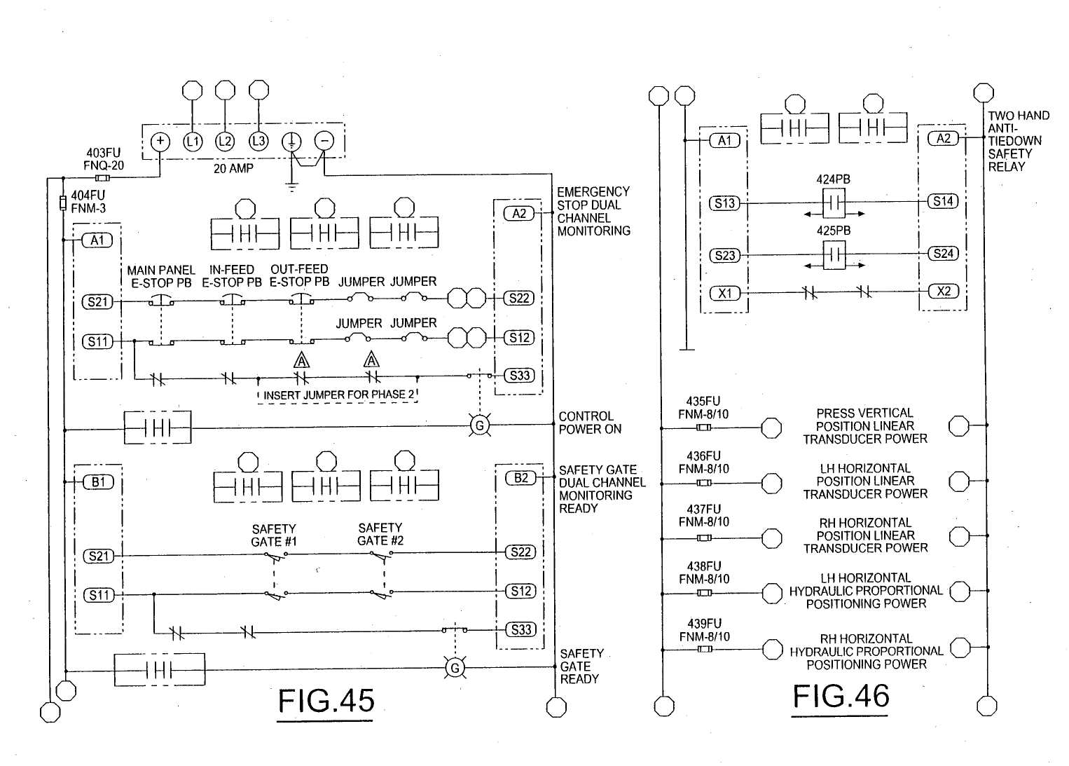

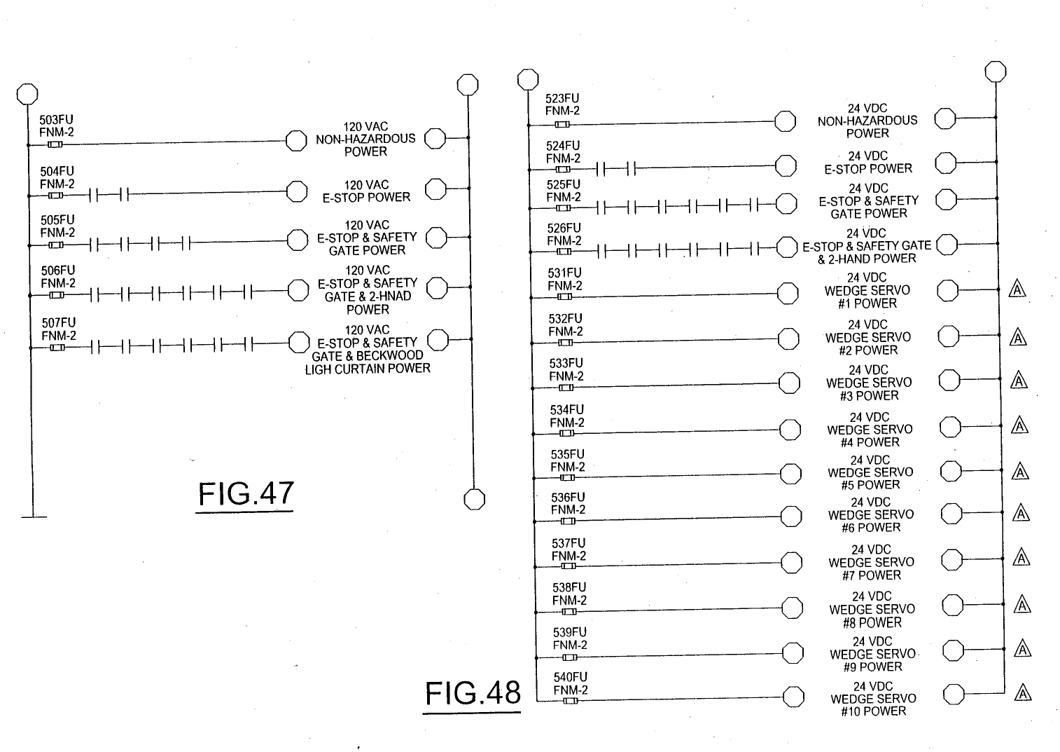

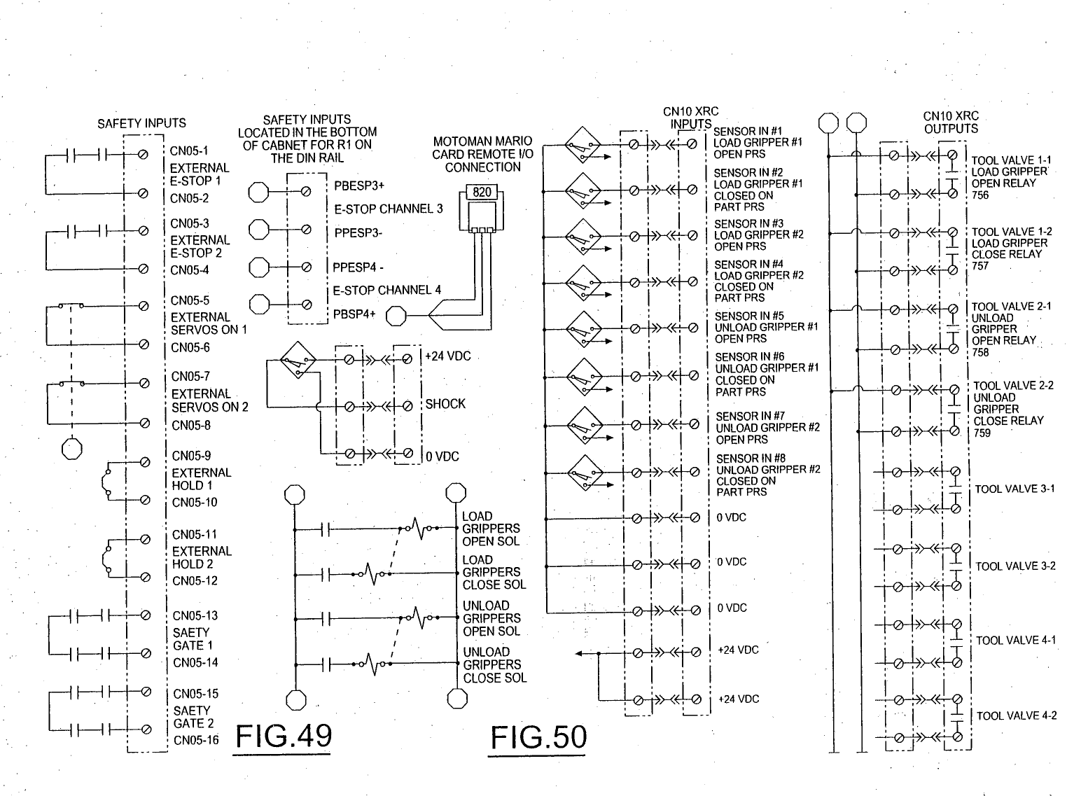

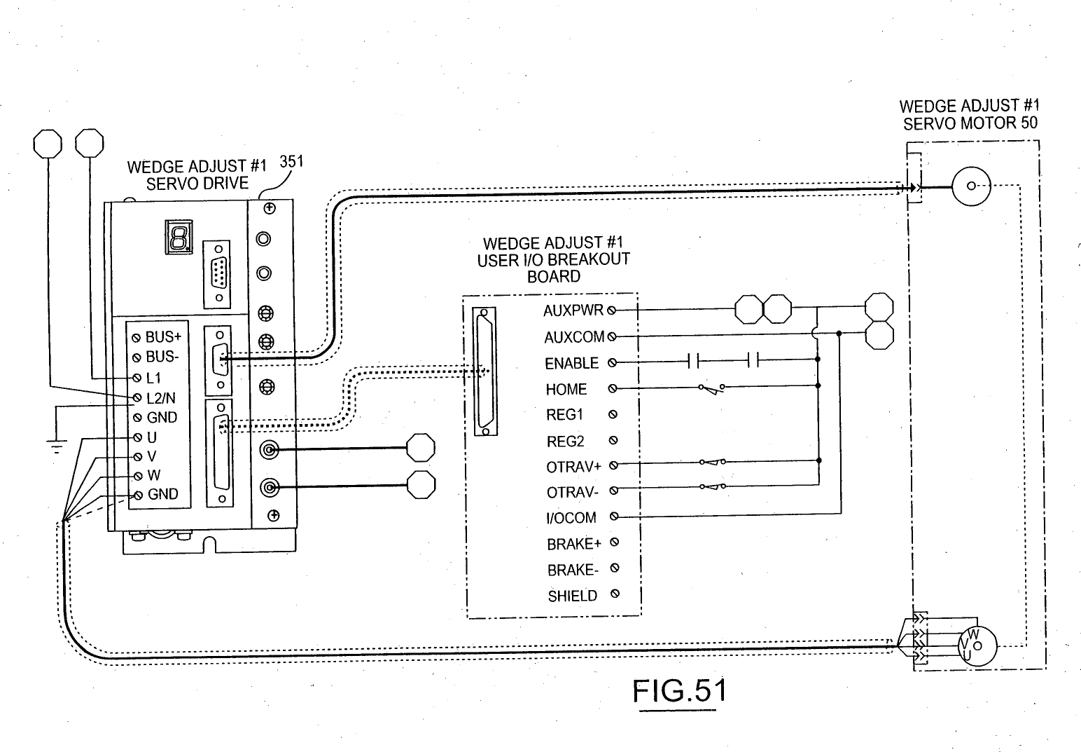

The electrical components and circuits for operating the robotic system 60 including the hydraulic press 62, die set 74, safety enclosure 72, gravity feed magazine loader 76, robot 80, electronic checking apparatus 92 and the reject table or station 94 are illustrated in FIGS. 41-50, inclusive. The technology illustrated herein utilizes a closed loop platform which incorporates the use of linear measurement instruments (LVDT) to monitor the final sweep of the bumper beam in the die set 74 following the forming operation. Errors in the contour in the bumper 12 are corrected by adjusting the inserts 360 of the male sweep mandrel 356 utilizing the servo positioning technology. Such technology includes the wedges 344, transfer blocks 338 and the electronic servo ball screw motors 350 which drive the inserts 360 up and down thereby refining the sweep in the bumper. The technology include the hydraulic cylinders 272 which are controlled with servo proportional valves 460, 462 discussed previously.

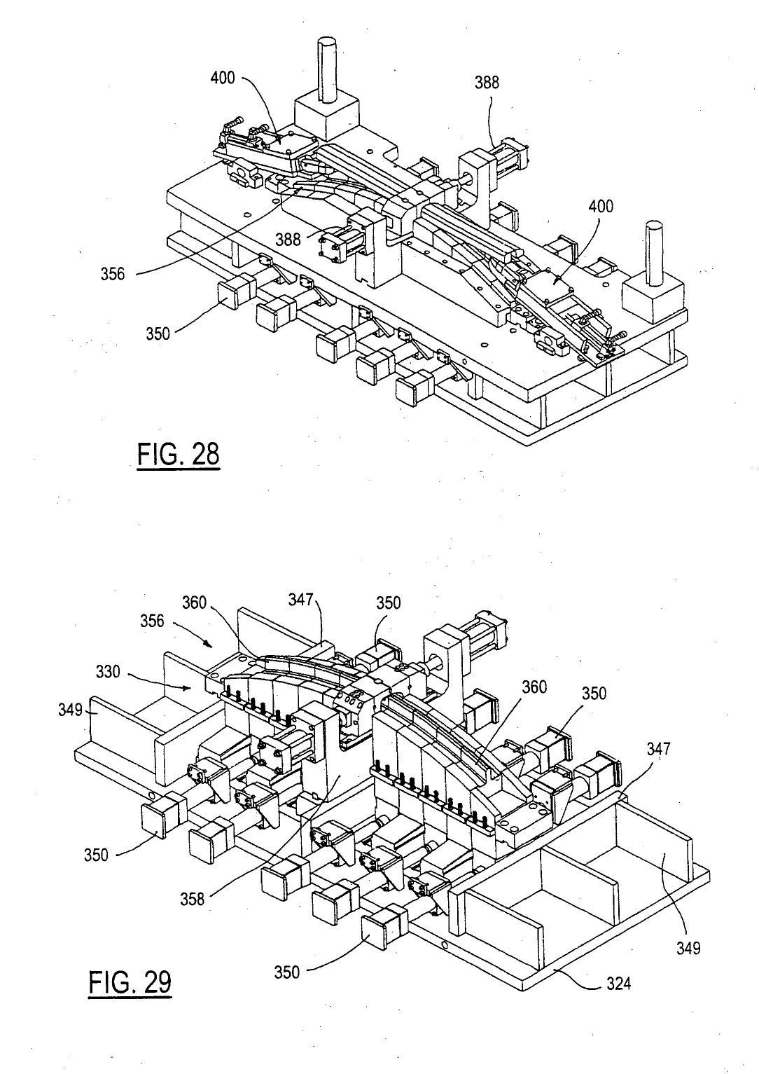

FIG. 51 illustrates a typical servo circuit for servo motor 350 and the wedge adjustment servo drive 351 for each of the wedges 344. The system utilizes ten wedges 344 and servo motors 350 as illustrated in FIGS. 27 and 28, each requiring a corresponding wedge adjustment servo circuit similar to FIG. 51.

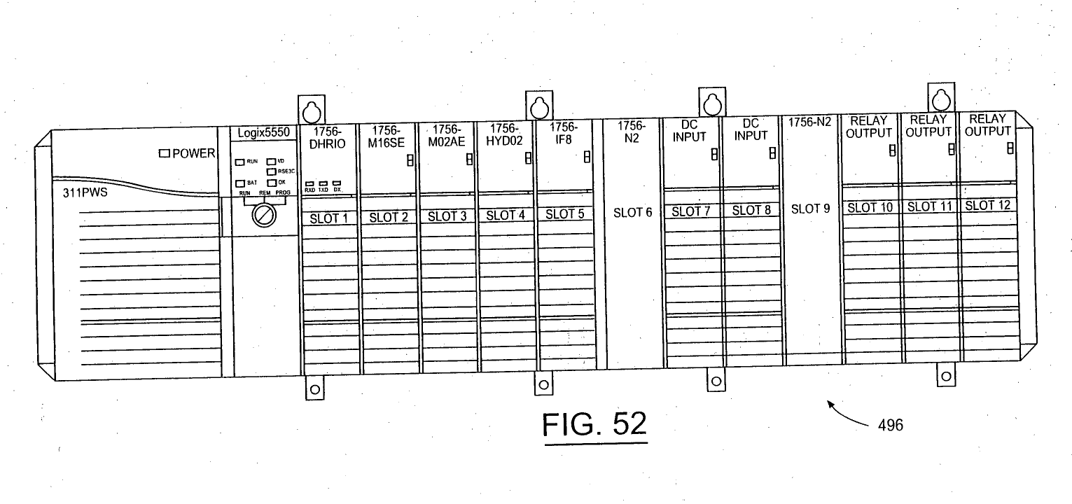

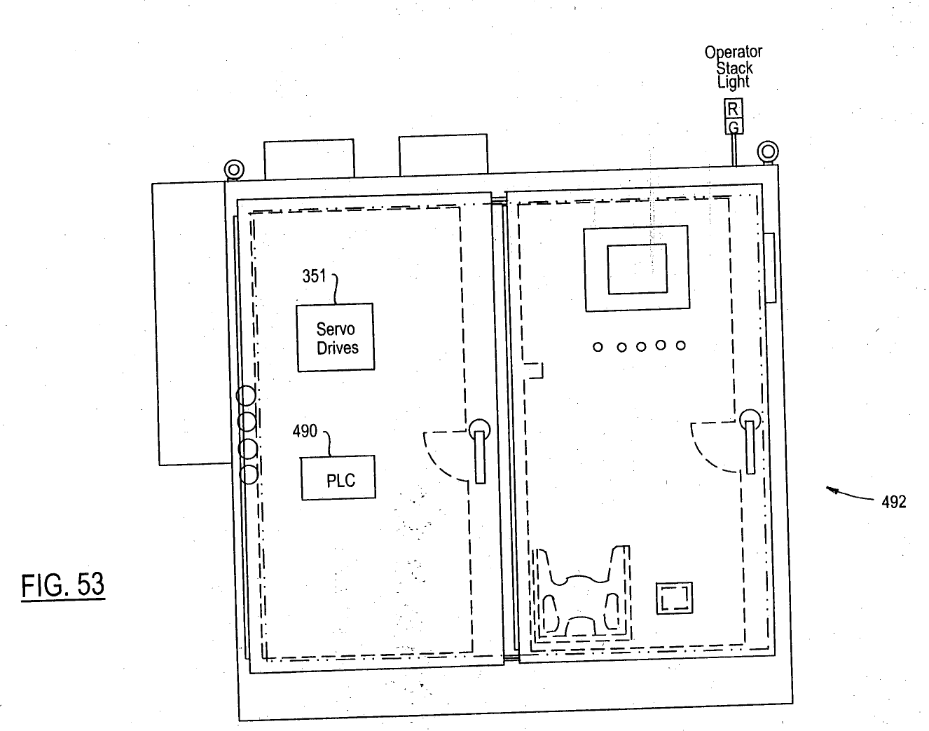

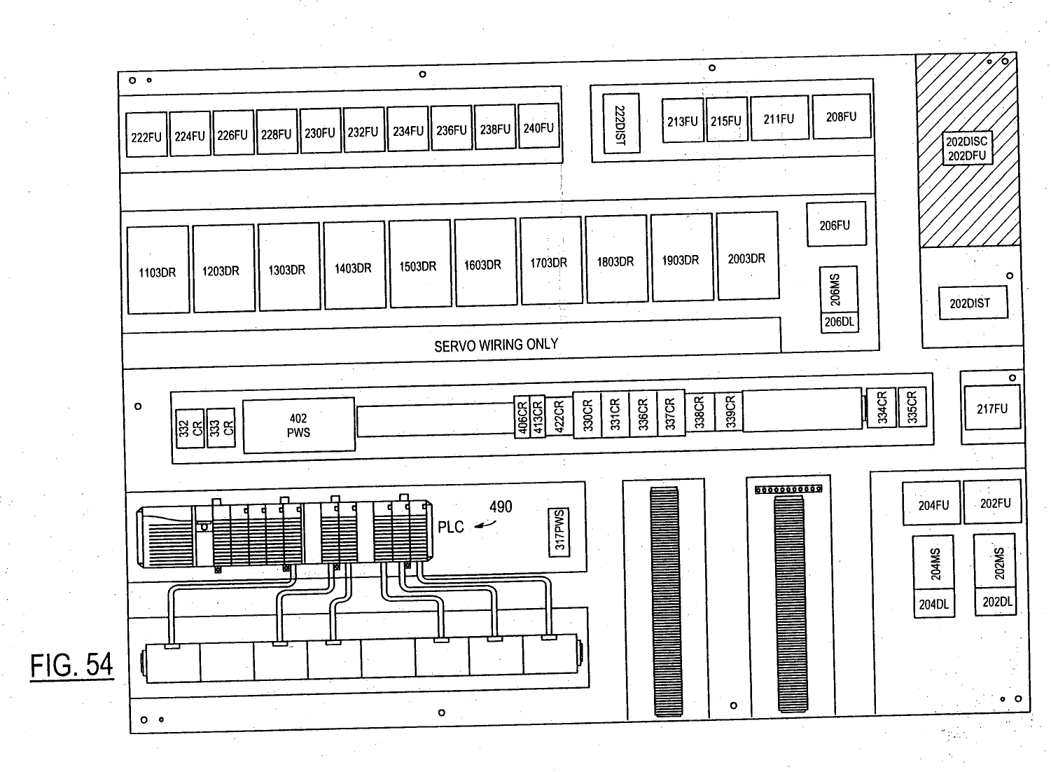

The robotic system 60 includes a programmable logic controller 490 as shown in FIGS. 52-54. It is located in the electrical panel 492 of FIG. 54 which is internally housed in the main electrical enclosure of cabinet 494 (FIG. 53). The rack layout 496 for the PLC 490 is illustrated in FIG. 52 and is electrically connected as illustrated in FIG. 53. The PLC is an Allen Bradley PLC processor with a 4M memory. The rack or chassis 496 is an Allen Bradley chassis with 13 slots, Series B. The PLC processor 490 receives input from a linear transducer and pressure transducer provided on the hydraulic press 62 as well as from the electronic servo ball screw motors 350 and other linear measurement instruments utilized in the robotic system 60. The electrical panel with the enclosure 53 provide various components for the operation of the press 62 and the entire robotic system 60, including the electrical servo drives 351. Electrical switches are provided throughout the robotic system to operate the equipment, power, safety gates, robot, press, etc. Emergency buttons are also provided to stop the press, loader 76, electronic checking apparatus 90 and the robot controller.

### Sequence Of Operations

The present invention discloses and describes a “center out” bumper sweep or robotic system 62. The system forms a sweep in a bumper beam by supporting a “B” section cross member 12 securely in a contour cut male sweep mandrel 356 at the center. Simultaneously, the opposed profile wiper blocks 378 with contours 380 cut to the rear surface profile of the cross member 12 are driven outward from the center by the hydraulic cylinders 372 while the hydraulic press 62 is driven downwardly simultaneously, forming the radius or curved bumper beam 10 around the male mandrel 356.

The contours 380 of the wiper blocks 378 encompasses the outside part of three sides of the cross member 12 while the fourth side is inside the curved center support or post 364 as can be visualized by referring to FIGS. 34 and 35. The wiper blocks actually iron the metal on the post 364.

The robotic system 62 integrates the inspection fixture or electronic checking apparatus or station 90 into the die set 74 which is tied into the hydraulic press 62. The robot 80 controls the cross members and bumpers between the loader 76 at the loading station, the die set 74 and the checking electronic apparatus 90 at the unloading station. The weight of the straight tubular cross members 12 at the gravity feed magazine loader 76 causes the cross members 12 to be gravity fed to the low end of the loader 76 as shown in FIG. 8. The system makes sure that each cross member 12 is in the same spot every time for the robot 80 to pick it up. The cross members 12 are gravity fed at about 10 degrees. The lift device 136 and pneumatic cylinder 138 provided with electronic grabbers at the low end of loader 76 are elevated and grabs towards the outside surface of the cross member. Thereafter the proximity switch 156 is actuated. So what happens is the grabbers grab the cross members 12 and locate them in the same position repeatedly since the robot always repeats itself within 10,000's. Thus, the cross member 12 is always located in exactly the right position. The first pair of electronic grippers 86 on the end effecter 84 on the robot 80 at the loading station or loader 76 picks up the straight cross member 12 and the robot 80, it is then swung over to the hydraulic press or bender 62. The end effecter 84 is rotated 180 degrees while the robot 80 is at the hydraulic press 62 and die set 74 to initially remove the bent or curved bumper 10 from the press 62 with the second pair of electronic grippers 88. Thereafter, the unbent cross member 12 is placed in the die set 74 and the robot 80 is then rotated and swung to the electronic checking apparatus 90. It is necessary to remove the curved bumper 10 from the die set 74 before the straight cross member 12 is loaded into the die set. It is important to keep in mind that the feed or loading station 76, the die set 74, press 62 and the electronic checking fixture 90 are all tied together with the electronics illustrated in FIGS. 41-54.

At the electronic checking apparatus 90 the curved bumper 10 is lowered by the robot 80 into a hold station or position on the checking fixture. A proximity switch is triggered which indicates that the curved bumper 10 is in the proper location. As a result the probe carrying slide 262 is activated by the cylinder 276. The probes 274 are actuated over the top surface of the curved bumper 12. Each probe has a stroke of approximately 0.5 inches and contacts and measures the bumper surface to determine whether or not the measurements meet the specifications.

If it does meet specifications the electronic data is fed to the PLC 490 which is the electronics to the hydraulic press 62. If the apparatus 90 indicates that the surface measurements are accurate the press 62 continues to cycle. If the measurements of the surface of the curved bumper 10 do not meet specifications and thereby constitute a bad part, the electronic information is fed to the PLC 490 and the press 62 is prevented from recycling. Corrective information is sent to the PLC 490, press 62 and to the die set 74 telling the electronic servo motors 350 to make the necessary adjustments and corrections. Once the servo motors 350 have adjusted the wedges 344 and corresponding transfer blocks 338 and the inserts 360, it feeds back information to the electronic checking apparatus 90 indicating that the adjustments have been made. The robot 80 which is at the electronic checking apparatus 90 picks up the bumper 10 with the inaccuracies and transfers it to the reject table or station 94.

In summary, if the electronic apparatus 90 determines that the measurements of the curved bumper 10 are inaccurate, the press 62 will not cycle. If the bumper is a bad part, the information is fed back to the PLC 490 and it tells the die set 74 so that it can move the various servo motors 350 and make the necessary corrections to the inserts 360. Once that task is accomplished, the information is fed back to the press 62 saying that it is okay since the adjustments have been made. The robot 80 which remains at the electronic checking apparatus 90 picks up the bad bumper and moves it over to the adjacent reject table and station 94. The robot 80 then swings greater than 180 degrees to the loader 76, the press 62 recycles and the sequence of operation is repeated.

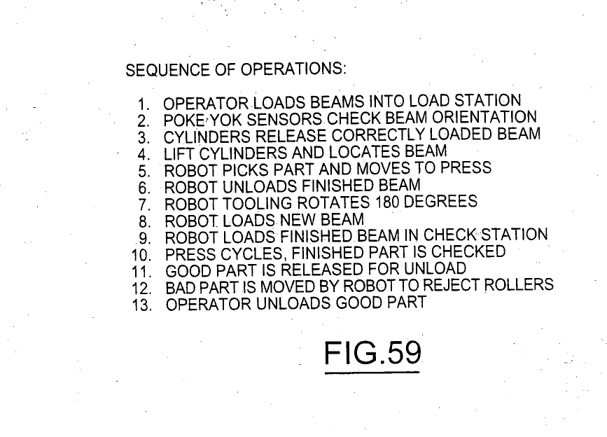

FIG. 59 illustrates a word chart which describes the various process steps involved.

An important feature of the present invention is the use of the hydraulic stabilizers 400 on the die set at the ends of the mandrel 356. The formation tool 406 (FIGS. 36-40) forming part of the hydraulic stabilizer 400 is configured to fit within and to contact and support the inner surfaces at the ends of the “B” shaped tubular cross member 12 during the formation of the a curved bumper 10. The plugs 410, 411 enter the ends for a depth of about 1.0 inch. It is necessary to maintain the “B” shape and to prevent the ends of the bumper from wandering from front to back and to prevent placing a twist in the part. Each stabilizer 400 has a pair of pivots since the stabilizer has to elevate and grab the cross member 12 when it is flat. The hydraulic cylinders 402 are tied in with the press hydraulics and fire at certain times as the press ram 62 descends.

The intermediate plate or die shoe 328 has an opening 332 cut therein which receives the transfer blocks 338. The opening 332 is reinforced in a pattern of zigzag grooves, not shown, provided in the bottom surface of the shoe or plate 328. The reinforcement prevents the plate 328 from flexing or breaking. When two wedges 344 are activated, they are going to adjust the transfer blocks 338. The plate 328 on top the wedge tooling 326 is divided within the zigzag opening, so that the wedges 344 can go up through the tooling.

The wedges 344 transfer the action. The electronic servo ball screw motors 350 drive the wedges 344 and the wedges 344 drive the transfer bars 338. Thus, the wedges 344 transfer a horizontal motion to a vertical motion. The servo motors 350 control the movement and provide precise movements for adjustment of the transfer bars or blocks 338. The shims or plates 343 provide wear surfaces between the transfer blocks 338 and the inserts 360. The purpose is to prevent scratching or scoring as the transfer blocks 338 are moving. It is well known that any time you have an item in motion, you have to provide a wear plate or surface to allow it to move freely.

The purpose of the springs 367 (FIGS. 30, 32 and 33) is to provide tension to hold the inserts 360, shims 343 to the transfer bars or blocks 338. The post or mandrel 356 is made up of the segmented inserts 360. It is well known that for every action, there is a reaction. Thus, there has to be a resistance to the action of the servo driven transfer blocks or bars 338. The springs 367 provide the resistance to the action of the servo driven transfer blocks 338. Without such an arrangement, fine adjustments are not achieved unless opposing forces are provided. The springs 367 are provided so that when forces are applied to the die set 74, the springs 367 make sure that the inserts 360 return to their original position.

The automated system will produce a curved bumper in approximately 50 seconds. If a bad part is produced, it immediately tells the hydraulic press 62 within about one second to not recycle. The press 62 does not cycle until the servo motors 350 with the wedges 344 make the necessary adjustments. The automatic system of the present invention allows you to feed back information from one system to another resulting in a process that usually allows only one part to be scrapped. The adjustments are directed to the PLC automatically without any further production of bad parts. Present technology requires the bumper to be checked physically by hand with probes or feelers. By the time such adjustments to the dies are made by hand another 100 to 200 parts or bumpers have to be scrapped. With the automatic checking system of the present invention once a bad bumper is made the system shuts down. No reliance is made on humans to adjust it. The servo motors 350 do it electronically from the PLC and then it reads back and indicates that it is ready to go. Thereafter the hydraulic press 62 cycles or fires and processes the next part. If the part or bumper 12 is accurate, the press 62 continues to operate.

It should be appreciated that after the system is adjusted, the process should continue to produce accurate bumpers 12. However, it must be remembered that every roll or coil of strip steel has a different carbon content therein that changes the way the bumpers are bent or formed. What is unique is that if during the production run a hard part of the steel coil is encountered, the present system will respond and make the necessary adjustments. What is innovative about the automatic system of the present invention is the electronic checking fixture 90 to the PLC 490 to the servos 350 that drive the wedges 344. The horizontal motion of the wedges 344 is transferred to the vertical motion of the transfer blocks 338, that, in turn, adjusts the inserts 360. Once the adjustments are made, the spring loaded segmented inserts 360 are locked in position which allows the mandrel 356 to bend the part or bumper to a correct dimension. When an adjustment is made to the segmented mandrel 356, even though you have an action and a reaction, once it locks into position, the servos 350 drive the wedges 344, that drive the transfer bars or blocks 338, that drive the spring loaded segmented posts 360. Once the wedges 344 are in the proper positions, then the servo motors 350 lock the position. Once the wedges 344 get into position, there is a lock mechanism that locks the posts or inserts 360 together so they do not float.

An advantage of the present automatic system, is that if a customer wants to make a different sweep on a bumper with the same cross section, it will require only a relatively small amount of programming change to complete and at minimum costs of a few hundred dollars. A competitor using existing systems would have to spend hundreds of thousands of dollars for sweep blocks and other components to make a different sweep on a bumper with the same cross-section.

The prior art roll formers have a constant sweep, meaning, it is in an arc. If the arc continues it will come around in the form of a circle. With the present invention, a system is provided whereby the sweep can be non-constant, depending on the curvature of the segmented inserts 360. The inserts 360 can be replaced to provide a bumper with a different curvature, without requiring additional or new tooling, except for the inserts 360. The top tooling 322 is servo-tooling, both vertically and horizontally. The slot slide transfer blocks 338 are servo-controlled to be set to any radius or sweep that is required.

The bumper 12 may also be air formed using mandrel 356. This means that the slide or wiper blocks 378 will not come down and touch the lowest inserts 360 at the ends of the mandrel 356. The wiper blocks 378 will be up off them. The ends of the bumper can be formed as required without touching the inserts 360. For every inch that press 62 comes down, you can control exactly how much sweep is provided. It the press is lowered one, two or three inches a different sweep is provided. Different curvatures are achieved by using the air technique just described.

1. A robotic system for forming a curved bumper from a straight bumper bar comprising:
a hydraulic press with a die set therein for placing curved surfaces on bumper bars; said press having a front, back and a pair of ends;
a gravity feed magazine loader at the front of the press near one end thereof;
an electronic checking apparatus at the front of the press near the other end thereof for measuring the surfaces on curved bumper bars;
said electronic checking apparatus being aligned with and spaced from said magazine loader;
a robot rotatable throughout 180° or more located in the space between said gravity feed magazine loader and said electronic checking apparatus in front of said hydraulic press and die set;
said robot having an end effecter having a frame and carrying first and second pairs of spaced apart grippers, with the first pair of grippers being closer together than the second pair of grippers;
said first pair of grippers designed to pick up and hold a straight bumper bar as it is delivered by said robot from said gravity feed magazine loader to said hydraulic press and die set; and
said second pair of grippers designed to pick up and hold said curved bumper bar after it has been removed by said robot from said hydraulic press and die set and delivered to said electronic checking apparatus.

2. The robotic system for forming a curved bumper from a straight bumper bar of claim 1, wherein said robot is at its home position at said gravity feed magazine loader where said first pair of grippers when actuated picks up a straight bumper bar; and
said robot is thereafter rotated to said hydraulic press and die set where the straight bumper is released from said first pair of grippers and placed in the die set where the bumper bar is thereafter curved by force applied by the hydraulic press.

3. The robotic system for forming a curved bumper from a straight bumper bar of claim 2, with the curved bumper remaining in the hydraulic press and die set, wherein said robot is rotated from said hydraulic press and die set to said gravity feed magazine where said first pair of grippers when actuated picks up another straight bumper bar;
said robot is thereafter rotated from said gravity fee magazine loader to said hydraulic press and die set where said robot and said second pair of grippers when actuated picks up the curved bumper from the die set;
the end effecter of said robot when actuated at said hydraulic press and die set is rotated 180° where the straight bumper bar is released from said first pair of grippers and placed in the die set; and
said robot is thereafter rotated from said hydraulic press and die set to said electronic checking apparatus where said second pair of grippers, when actuated, deposits the curved bumper on the electronic checking apparatus for checking the measurements of the curved surface on the bumper.

4. The robotic system for forming a curved bumper from a straight bumper bar of claim 3, wherein said robot, when unloaded, is rotated from said electronic checking apparatus to said gravity feed magazine loader where the sequence of operation is repeated where the first pair of grippers picks up and hold a straight bumper bar and is thereafter delivered by the robot to the hydraulic press and die set.

5. The robotic system for forming a curved bumper from a straight bumper bar of claim 2, wherein said robot rotates through 90° between the gravity feed magazine loader and said hydraulic press and die set; rotates 90° between said hydraulic press and die set and said electronic checking apparatus; and rotates 180° between said electronic checking apparatus and said gravity feed magazine loader.

6. The robotic system for forming a curved bumper from a straight bumper bar of claim 1, wherein the gravity feed magazine loader has a low end and a high end and has a downwardly sloping top surface which includes a pair of laterally spaced apart roller conveyers, said loader being manually loaded at the high end of the loader to permit the straight bumper bars to be fed by the rollers by gravity to the low end of the loader.

7. The robotic system of claim 6, wherein the front end of the loader is provided with a pneumatically operated lifting device for raising the adjacent bumper bar from said top surface of the table to permit the bumper bar to be gripped by the first set of grippers provided on said end effecter.

8. The robotic system for forming a radius bumper from a straight bumper bar of claim 1, wherein said electronic checking apparatus has an inclined top surface and includes laterally spaced apart rollers extending from one end to the other end, said apparatus including a second frame having legs at the corner, with the legs being generally the same height;
a generally horizontally extending frame support carried by the upper ends of the legs of said second frame;
an ejector mechanism mounted on said second frame having an open position and a closed position;
a slide on said second frame for receiving and positioning a curved bumper; and
an electronic fixture carried by said slide and moveable over the curved bumper for electronically recording the curvature of the curved bumper at various locations.

9. A die set for forming a curved bumper from a straight bumper bar comprising:
an elongated upper plate for supporting the top die tooling;
an elongated lower plate for supporting the wedge adjustment tooling;
an elongated intermediate plate interposed between the top die tooling and the wedge adjustment tooling for supporting the bottom die tooling;
a center opening in said intermediate plate;
a center pedestal in said center opening with the bottom of the pedestal supported by said bottom plate;
a series of transfer blocks located in said center opening on opposite sides of said pedestal, each transfer block having a top surface which is flat and a bottom surface which is tapered;
a series of wedges located on opposite sides of said pedestal, one wedge for each of said transfer blocks;
the top surfaces of said wedges being tapered and engagable with the opposing bottom tapered surfaces of said transfer blocks;
actuating means connected to each wedge;
a contour cut male sweep mandrel mounted above said transfer blocks including a centrally located support block secured on the lower end to said pedestal; said mandrel including a series of vertically adjustable inserts located on opposite sides of said support block, one insert overlying and being aligned with one of said transfer blocks and the corresponding wedge;
the top surfaces of the inserts of said mandrel having an upstanding curved center support located between a pair of elongated recesses extending from one insert at one end of the mandrel to the insert at the other end of the mandrel;
said upper plate being located above said mandrel overlying and spaced from said intermediate plate;
said upper plate having on the ends thereof downwardly extending mounting brackets, one bracket on each end of said upper plate;
a pair of hydraulic cylinders mounted outboard of said upper support plate and carried by said mounting brackets;
said cylinders having a common longitudinally extending axis;
each cylinder having a shaft extending inboard of said brackets beneath said upper plate along said longitudinally extending axis;
a pair of opposed wiper blocks carried by said upper plate and mounted above said male mandrel on the opposing shafts of said power cylinder;
said wiper blocks having curvatures corresponding to the profile of the bumper bar; and
said power cylinders when energized moving said wiper blocks away from each other across the top of the bumper bar towards opposite ends of the mandrel to provide a radius thereon.

10. The die set for forming a curved bumper of claim 9, wherein there are an equal number of inserts, transfer blocks and wedges on each side of said center pedestal.

11. The die set for forming a curved bumper of claim 9, wherein the opposite ends of the intermediate plate is each provided with a hydraulically operated stabilizer including a portion designed to fit within the “B” shaped cross section of the bumper bar to prevent the ends of the bar from twisting and from wandering front to back while at about the same time said pair of wiper blocks are moved downwardly and outwardly away from one another to iron the bumper bar around the post from one end of the bumper bar to the other end of the bumper bar.

12. The die set for forming a curved bumper of claim 9, wherein said inserts at each side of said centrally located support block are of different heights, with the one insert adjacent the support block being greater in height than the other inserts.

13. The die set for forming a curved bumper of claim 9, wherein said centrally located center block is provided with a clamping mechanism for positioning and retaining the bumper bar on the contour cut male sweep mandrel.

14. The die set for forming a curved bumper of claim 9, wherein said actuating means connected to each wedge is taken from the group comprising (a) a manually adjustable threaded rod with adjustment nuts; (b) a hydraulic cylinder; or (c) electronic servo ball screw motor.

15. A gravity feed magazine loader for receiving straight bumper bars comprising:
an elongated frame with a longitudinally extending axis and having a front, a back and a pair of sides;
said frame having legs at the corners, with the legs at the back being longer than the legs at the front;
said frame having a pair of parallel outboard side members inclined downwardly from the back to the front connecting respectively the upper ends of the legs at the back and at the front thereof;
said frame having an upper cross member connecting the outboard side members at the back;
said frame having a pair of laterally spaced apart support elements at the front which are arranged parallel to said upper cross member and are mounted on and carried by the legs at the front;
a pair of parallel roller conveyors on opposite sides of the longitudinally extending axis, said conveyors being spaced inwardly from said outboard side members and are inclined downwardly from the back to the front and are supported by said upper cross member at the back and said upper support elements at the front;
a vertically mounted lift device secured to the front of said frame and in between said parallel outboard side members, said lift device including a pneumatic cylinder with a piston and rod movable therein, said rod having an end extending outwardly from said cylinder; and
a platform secured to said end of the rod for receiving and lifting a straight bumper bar at the front of the roller conveyors when said lift device is energized.

16. The gravity feed magazine loader of claim 15, wherein a pair of laterally-spaced apart side guards are mounted on the top of said frame generally above said outboard side members for assisting in retaining the straight bumper bars therebetween.

17. The gravity feed magazine loader of claim 16, wherein said side guards at the back of said frame have ends flared outwardly away from one another.

18. The gravity feed magazine loader of claim 15, wherein a center cross brace extends between said outboard side members and supports said roller conveyors.

19. The gravity feed magazine loader of claim 15, wherein the bottom surfaces of said legs are provided with base plates, each plate having a vertically adjustable jack screw for providing a means for leveling the frame and to prevent movement of the table when subject to vibrations.

20. The gravity feed magazine loader of claim 15, wherein each roller conveyor comprises a pair of laterally spaced apart channel members and a series of rollers having the ends carried by the channel members, with the rollers being closely spaced together.

21. The gravity feed magazine loader of claim 15 wherein the angle of inclination of said side members and said roller conveyors is approximately 10° to permit the weight of the bumper bars to gravity feed them from back to front.

22. The gravity feed magazine loader if claim 15, wherein the rod of the cylinder is provided with a pair of grabbers for engaging the outside surface of a bumper bar.

23. The gravity feed magazine loader of claim 16, wherein an electrical proximity switch is provided at the front of the frame which, when activated, signals that the bumper bar is ready for the next step.

24. An electronic checking apparatus for measuring the curved surfaces on swept bumper bars comprising:
an elongated first frame with a longitudinally extending axis and having a front, a back and a pair of sides;
said frame having legs at the corners, with the legs at the back being longer than the legs at the front;
said frame having a pair of parallel longitudinally extending side members respectively connecting the upper ends of the legs at the front and at the back thereof;
a plurality of transversely extending cross members interposed between said outboard side members;
an upper support plate carried by said side members and cross members;
a pair of longitudinally extending series of rollers mounted on opposite sides of said upper support plate and located above said side members;
a second frame having legs at the corners thereof, with the legs being of generally the same height;
a generally horizontally extending frame support carried by the upper ends of the legs of said second frame;
a top plate mounted on said frame support;
said second frame having a front, a back and a pair of sides;
the legs of said second frame at the front being opposite and spaced from the legs at the back of said first frame;
an ejector mechanism mounted on said second frame having an open position and a closed position;
a slide on said frame support for receiving and positioning a swept bumper bar;and
an electronic fixture carried by said slide and movable over the swept bumper bar for electronically recording the curvature of the swept bumper bar at various locations.

25. The electronic checking apparatus of claim 24, wherein said electronic fixture has a plurality of laterally spaced electronic probes engagable with the curved surfaces of the swept bumper bar, with the electronic probes transmitting the electronic data to a recording station.

26. The electronic checking apparatus of claim 24, wherein a pair of laterally spaced apart side guards are mounted on the top of said first frame outboard of said pair of longitudinally extending series of rollers.

27. The electronic checking apparatus of claim 26, wherein said side guards at the front of said first frame have the ends flared outwardly away from one another.

28. The electronic checking apparatus of claim 24, wherein the bottom surfaces of the legs on said first and second frames are provided with base plates, each base plate having a vertically adjustable jack screw for providing a means of leveling the frames and for preventing movement of the apparatus when subjected to vibrations.

29. The electronic checking apparatus of claim 24, wherein each series of rollers comprises an upstanding elongated flange with rollers mounted on opposite sides of the flange at close proximity to one another.

30. The electronic checking apparatus of claim 24, wherein said ejector mechanism is pivotally mounted on the top of said second frame, said mechanism when in the open position prevents the bumper bar when checked from proceeding along the rollers to the exit end thereof but permits the bumper bar, if inaccuracies are found, to drop through the opening provided by the ejector mechanism into the space below the ejector mechanism.

31. The electronic checking apparatus of claim 24, wherein said ejector mechanism is pivotally mounted on the top of said second frame, said ejector mechanism when in the closed position permitting the bumper bar when checked and determined to be accurate to traverse the series of rollers to the front of the first frame.

32. The electronic checking apparatus of claim 24, wherein the legs of said first frame are vertically adjustable to vary the slope of the side members and the pair of series of rollers.

33. The electronic checking apparatus of claim 24, wherein a lift device is carried by said second frame and is secured to said ejector mechanism for opening and closing same.

34. An end effecter for a robot comprising:
a frame having a pair of spaced apart parallel side members, an end gripper support member extending perpendicular to one end of said side members and secured thereto and a cross brace located between and secured to the other end of said side members;
a robot clutch assembly located in the space between said spaced apart side members and secured thereto;
a first pair of spaced apart grippers located on the ends of said gripper support member; and
a second pair of spaced apart grippers secured to the other end of the pair of spaced apart side members.

35. The end effecter of claim 34, wherein each pair of grippers consist of a pair of spaced apart elements having curved surfaces adapted to grip curved surfaces on a bumper bar.

36. The end effecter of claim 34, wherein said first pairs of grippers are spaced further apart than the second pair of grippers, with the first pair of grippers designed to contact the curved surfaces provided on the swept bumper bar.

37. The end effecter of claim 34, wherein a second pair of grippers are designed to grip the curved surfaces provided on a straight bumper bar, the second grippers being closer together than said first grippers.

38. The end effecter of claim 34, wherein the robot clutch assembly includes a clutch having a stop surface with a plurality of openings therein through which cables may be introduced into the structure.

39. The end effecter of claim 34, wherein said clutch includes means for permitting the end effecter to rotate.

40. The method of forming a curved bumper from a straight elongated roll formed bumper bar of “B” shaped cross section having two side-by-side, box-like tubular sections connected together by a web, with each section having a front wall, an outer side wall, a rear wall and an inner side wall comprising:
placing and securing the straight elongated bumper bar on an elongated curved mandrel having a center post and a pair of parallel elongated grooves on opposite sides of the center post, with the post and grooves extending from one end of the mandrel to the other end, with the bumper bar tubular sections and the web facing respectively the pair of elongated grooves and the post; and
directing a pair of wiping tools across the top of the bumper bar starting at the center and moving the tools outwardly and downwardly so as to urge the tubular sections into the opposite grooves and the web around the post of the mandrel to form the radius bumper.
